(19) United States
(12) Patent Application Publication
(10) Pub. No.: US 2002/0087377 A1
(43) Pub. Date: Jul. 4, 2002

(54) Lobor arbitrage to improve healthcare labor market efficiency in an electronic business community

(76) Inventors: Terry X. Rajasenan, Pittsburgh, PA (US); Anup Swamy, Boston, MA (US)

Correspondence Address: H JAY SPIEGEL, P.O. BOX 444, MOUNT VERNON, VA, 22121, US

(21) Appl. No.: 10/020,185

(22) Filed: Dec. 18, 2001

Related U.S. Application Data
(60) Provisional application No. 60/256,952, filed on Dec. 21, 2000.

(51) Int. Cl. G06F 17/60

(52) U.S. Cl. 705/7; 705/1; 705/8

(57) ABSTRACT

A method of conducting a labor arbitrage between a plurality of health care facilities involves creation of an electronic business community made up of those facilities. Information is compiled concerning all employees of each health care facility with the information being supplied to an exchange hub. Labor resources of each facility are assessed and put and call option orders are derived for each facility having labor assets and/or labor requirements. Deals are negotiated between at least two of the facilities and agreements are prepared and executed.

### BACKGROUND OF THE INVENTION

The present invention relates to electronic exchange of labor using an electronic network, and, in particular, to a method of conducting electronic labor exchange that allows participants to arbitrage labor during a bidding session to improve workforce planning and long-term labor cost efficiency. The target market is the Healthcare Industry, with segments being located throughout the entire Continuum of Care (from Assisted Living Facilities on upwards, in terms of acuity, to Acute Care Facilities), focusing on the reassignable or schedulable labor in the facility, such as the Nursing department or Dietary staff.

The present invention has a substantial business need it intends to fulfill. One of the top challenges facing business today is supplying labor to fill demand cost-effectively. Nowhere is this more urgent than in today's Healthcare Industry. With increasingly tight labor markets, an aging population, and increased requirements for workers at all levels, any solution that enables the labor supply chain to more efficiently deliver the proper worker to cover demand can dramatically increase any organization's productivity. This, in turn, can offer a valuable—if not the only—means to improve profits significantly. It is estimated that businesses in the United States spend over $20 billion annually trying to achieve this result. Unfortunately, as recent high-profile bankruptcies have demonstrated, the Healthcare Industry still hasn't found an answer.

Long Term Care's largest controllable cost (nearly 80%) is labor, and labor is also what drives the LTC facility's ability to provide quality care. Yet, even with labor's impact on cost and quality being so profound, innovations that can secure the staffing necessary to maintain operations have been limited at best. Attempts to hire more PRN staff, create mentoring programs for new hires, and develop pipelines with schools and even foreign worker programs have all met with varying degrees of success in near-term and long-term staffing improvement. However, in the end, the greatest challenge to reasonable cost and quality goals has been the rising influence that Agency Staffing is having on the LTC industry.

Not only is the Agency considered a competitor for the most critical resource the LTC facility needs (i.e. labor), it unfortunately has increased its hold as the supplier to the industry of that resource—and usually at 50-100% or more in premiums. Interestingly, the Agencies only pay, on average, 10-20% higher wages than those offered at the LTC facility. Given these two facts, it should come as no surprise that Temporary Staffing Agencies in healthcare will annually net $3 billion more in revenues than they expend in payroll. Some in the industry considers this, the tax that Agency staffing places on healthcare operations.

There are additional problems, though. Quality is generally considered lower with Agency staff (given the importance of Continuity of Care), and the morale impact is even more insidious. One category of in-house worker views the Agency staff person as less committed and therefore less helpful to the care doctrine they want to uphold, while the other category of in-house worker sees the “grass being greener” on the Agency side. Many facilities claim they can't even get responses now from their help wanted ads due to their inability to compete against the Agencies who, in their eyes, “steal away” their best PRN staff prospects.

This technology and process are quite valuable to the Healthcare Industry. Rising labor costs, exacerbated by labor shortages, and revenue caps (due in large part to the Prospective Payment System initiated by the Balanced Budget Act) have placed extreme margin pressure on all facilities. This problem is especially pronounced in the Long-Term Care (LTC) segment of the industry, as witnessed by significant bankruptcies of major LTC chains and organizations. Since 1998, half of the top 10 LTC chains have entered into bankruptcy, or merged to reduce costs. Moreover, questions have arisen regarding their capability of delivering quality care. In fact, states like Texas are seeing their governments become actively involved in trying to ensure adequate staffing levels at the LTC facilities in their state.

Given these margin pressures and quality concerns, the entire industry is looking for cost-effective ways to maintain staffing levels. However, they are forced to complete with Temp Agencies for scarce staff, which usually pay their staff 10-15% more than the industry, but charge facilities rates 50-100% more than the facilities would have to pay their own staff. In addition, the quality impact of Agency staff is also negative, according to many facilities, as Continuity of Care and service commitment usually suffer as Agency staff do not have time or the will to focus on learning the needs of facility patients or residents. Thus, facilities are looking for a means to “bypass” Agencies and develop their own coordinated staffing pools.

The goal of healthcare facilities currently is to reduce costs without compromising service. They need a viable means to cost reduction, as opposed to “panic” cost-cutting, when faced with the margin pressures or crises. The present invention offers a new way to save money that was not viable before, either due to a lack of information, or a lack of managerial time to capitalize on this perishable information that represents the fleeting opportunity to save money, maintain morale, and/or improve quality.

### SUMMARY OF THE INVENTION

The present invention relates to a labor arbitrage to improve healthcare labor market efficiency in an electronic business community. Applicants have observed, in various forms and in multiple industries including healthcare, the notion of pooling and coordinating labor resources among two or more facilities. This shared staffing concept ranges simple to complex. Simple encompasses the “co-oping” of some of the HR and training functions to develop better pipelines of new employees. The complex concept includes creating more sophisticated procedures for truly “co-operating”, such as offsetting critical shortages in staffing at one facility with extra staffing from another. This latter innovation offers the greatest potential impact to the LTC facility.

In order to reduce the “paradigm shift”, it is helpful to draw parallels with items facility management has already seen. The Shared Staffing model extends the familiar concepts of:

1. Switching employees between staffing units on a Daily Staffing Sheet—now there are just more unit options to switch to and from.

2. Employing part-time and PRN staff that work at one or more other facilities besides your own facility—now we are simply coordinating them in a way that offers benefits to every facility where they may work.

3. One may visualize the key elements of the process using the following diagram:

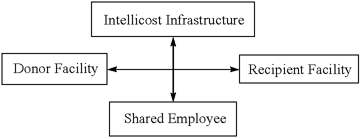

Shared Staffing begins with a legal concept first. Joint Float Pools (JFPs), as we have termed them, are essentially coordinated PRN pools of a new class of employee—one that would otherwise be beyond the reach of typical facilities trying to entice the typical PRN employee. An employee in a JFP is “jointly employed” by all facilities that wish to participate in sharing staff, and placed into a new “classification” of employee that is common to all the participating facilities. In this way, every facility does its due diligence in accepting the JFP employee into their workplace. The legal objective here is to “mitigate cross claims”—that is, make the liability risk of using the JFP employee the same or even less than either using an Agency staff member or overworking your current staff. There are other aspects to consider, such as transaction agreement language, but once again, the first step is the JFP.

The present invention includes the following interrelated objects, aspects and features:

(1) As many of today's businesses are trying to figure out how to use the Internet to improve their supply chain, Applicants are initiating a vertical portal for healthcare labor (healthlaborexchange.com), in order to efficiently allocate and exchange labor among units to be staffed. This portal will employ the labor arbitrage process being detailed here for its exchange mechanism. Customers will be attracted to Applicants' business-to-business exchange (an electronic hub) given the “deep content” of labor planning and cost reduction, especially pertaining to the exchange of actual float pool staff. The hub uses Optimization and Arbitrage techniques to manage labor and reduce dollars “wasted” throughout the Labor Value Chain. By automating the modeling, planning, and coordination of staffing in the entire supply chain, the vertical hub allows business to more efficiently manage their labor supply in either a single site or throughout an Electronic Business Community (EBC). Applicants help to correct current labor inefficiencies by being able to “arbitrage” labor between businesses, as well as among “free agents” (e.g., contract workers) and businesses in need of their services. Applicants use intelligent systems and the Web to help labor markets run more efficiently—in short, “program trading” for labor markets.

(2) Applicants' type of “coordinated” staffing pool can offer a “win-win-win” to each of the facilities exchanging labor to reduce their costs, as well as the employee getting higher wages and more work shifts. This is the key advantage of arbitrage—everyone can win, including the firm offering the capability to the market. In fact, Applicants' projections estimate that they can improve profitability in the Healthcare Industry by 20% or more with the help of this type of technological capability.

(3) One “value proposition” to customers is the avoidance of temp agencies, (and their costly “double-the-normal-wages” rates), and the new capability to move excess staff to cover for the deficits that require agency usage. It offers savings in the form of reduced “overstaffing” payroll costs for the “donor” facility, as well as reduced “overtime or agency” payroll costs at the “recipient” facility. Note that, on different occasions, any facility could be either a donor or recipient, depending on their current staffing situation. One measure of the potential impact of the technology on the industry is the amount of money that Temporary Staffing Agencies, focusing just on those serving the Healthcare Industry, in the United States make from Healthcare facilities and providers. Their revenues minus their payroll they pay to their temp workers is over $3 billion annually.

(4) The process for this critical technology of Applicants' business-to-business labor exchange hub basically coordinates the assignment of labor among intra-organizational and inter-organizational departments. It offers “networked labor” where there is a “cluster” of facilities or entities within sufficient geographic proximity as to enable transfers of labor. It enables the EBC to essentially connect all fungible labor supplies to the dispersed demands for labor. Analogous to financial markets, Applicants provide a means for “staffing liquidity”—valuable given Metcalfe's Law, which states that utility value of a network increases exponentially with the number of users (i.e., utility=users squared). Examples can be found not only in large stock exchanges but in such mundane items as the telephone—it is much more valuable when you can call everyone in the world, not just one person.

(5) There is a significant justification for arbitrage over just bulletin boards or auctions for labor. Current Internet auctioneers like eBay™ and Priceline.com™ know the value of the commodity being auctioned in terms of only one party (i.e., eBay™—only the seller, Priceline.com™—only the buyer), and then allow the “free” market to determine whether a deal can be reached between two parties. They merely provide a forum for users to interact in a structured market environment. Arbitrage, though, reduces chances of one side getting “suckered” (which is a big complaint of auction or reverse auction sites). Many companies cannot arbitrage items on their web sites due to one of two reasons. First, they may not have the technological capability to gather the necessary (pricing) information that values the commodity for both parties involved. Or, second, it is because they deal with commodities and non-perishable assets that have relatively predictable values wherein the “free” market simply “matches” buyers and sellers, which leaves no room for arbitrage selectively toward maximum, mutual return. A perishable asset with an unpredictable and complexly derived value, like labor shifts in a dynamic labor utilization environment, cannot be efficiently matched in the “free” market. This presents a tremendous opportunity for arbitrage, on which the inventive arbitrage mechanism can capitalize.

Bulletin boards have different challenges. According to press releases, sites like Monster.com™, ICPlanet.com™, and Free Agents™expect to profit by charging companies who are seeking short-term talent. Many of the sites want contractors to pay as well, not for services that match them with companies, but for additional benefits like group-rate insurance.¹ ¹“Sites to Help Professional Workers Who Like to Go It Alone” New York Times, Oct. 14, 1999

The key challenges, however, according to those in the industry, are:

(A) How does a free agent find and accommodate new work while doing their current work?

(B) How many businesses will actually be on the buying side?

The second point is especially important, as it does not appear to be a huge number. In September of 1999, for example, the Free Agent™ bulletin board appeared to have only 27 listings for companies seeking professional help on projects. Most were related to technology, although the single listing in the entertainment category offered one lucky professional the opportunity to direct the shooting of a feature film in Portugal. Thus, it appears advantageous to focus on building an EBC of the buyers of labor first, not the sellers.

In addition, the usual problem of building liquidity for an intermediary is that it is difficult to attract buyers without sellers and difficult to attract sellers without buyers. However, given that a buyer of Applicants' labor derivative (i.e., the fill-in or offload “option orders”) could also be a seller in the same batch of transactions, all that is needed is to concentrate on attracting business participants. In order to maintain the participation level, the benefit to both sides is maximized rather than favoring just one side. Investment is critical to gain mindshare and increase liquidity, thus, focusing on the Labor Management content first, should result in a better position to achieve this goal. This is because the perceived value is usually higher on the labor budgeting and planning side of the equation.

(6) The Business Model of the firm employing this technology and process is as an Application Service Provider that can “disintermediate” the Temp Agency (or instead can be a software tool at each participating facility that is connected via an electronic network, such as the Internet). The foundation of the employee-transfer is the “Joint Float Pool” wherein the most flexible staff are hired by all participating facilities. They have incentive to move between facilities by potential incentives based on the percentage of savings the facilities estimate they will gain by doing the transfer. Fees are taken either as subscription fee or taking the “spreads” between the bid vs. ask in the orders involved in the deal.

(7) The general principle for improving the labor efficiency is analogous to techniques used in financial markets. It is essentially “program trading” between staffing units, wherein labor (i.e., the willingness and ability to work at a particular type of assignment) is considered to be the underlying transferable asset or commodity. Staffing units can be either within or among facilities. The financial return of the trades is maximized for the market using arbitrage of labor “derivatives”—essentially put and call options on the underlying asset, which in this case is labor.

(8) In order to accomplish the present invention, an electronic exchange of labor is conducted over an electronic network that includes a server system for hosting the transaction, and client terminals connected to the server via an electronic communication network. Various client/server architectures may be used. The server side of the system preferably comprises at least one database, an exchange processor. The client side can be any suitable client terminal, which includes software for all participants.

(9) The present invention may include the step of requiring a client to pay a subscription fee to partake in the bidding process. A client can be, but not limited to, a corporation, partnership, Limited Liability Corporation, subsidiary companies, or a department within one of the aforementioned facilities.

(10) Before a client can participate in labor arbitrage, a client must complete several preliminary steps. First, a client must submit a complete list of the client's employees. Second, a client must submit an employee attributes list, which identifies the probability of an employee moving between facilities. Third, a client must submit a staffing plan that identifies the work schedule of the client's employees, as well as employee's vacation schedule. Fourth, a client must update scheduling information whenever there is a change. A client will complete these steps using electronic forms. Once a client completes each electronic form, the form is submitted over an electronic network to a designated server.

(11) A client must also submit and designate an acceptable bidding range. A client will submit a bidding range establishing the minimum amount the client expects to pay and the maximum amount the client will pay in order to fulfill a staffing need. A client will submit a bidding range establishing the maximum amount the client expects to receive and the minimum amount the client expects to receive in order to offload an over supply of staffing.

(12) The server receives and stores the information in a client database. The information is then analyzed to determine what are the client's labor resources and what are the client's labor resource needs. Then, the technology determines the optimal allocation of the client's in-house labor resources. Then, the technology identifies the client's needs that cannot be fulfilled by the client's in-house labor resources, essentially areas requiring the client to buy resources. Finally, the technology identifies areas where there is a surplus of in-house labor resources, essentially areas where the client can supply staff.

(13) After the client's data has been analyzed, the data is uploaded to a centralized server. This can be done using a simple messaging mechanism that attaches the orders file to an e-mail that is sent to the “hub” (central server) to process. In this method, the data can be sent to and processed by the hub at designated intervals. Or instead, the creation of orders can initiate send processes and then run the server processes via Java's Remote Method Invocation. The data can also be acquired by thin clients, whether applets or servlets, capturing all necessary data and process the data at the server. The client's data is aggregated with the data of other clients. Based upon supply and demand of each client, as well as each client's bidding range, a closing price is determined through the arbitrage process. Each client is notified of pre-approved deals.

Accordingly, it is a first object of the present invention to provide a labor arbitrage to improve healthcare labor market efficiency in an electronic business community.

It is a further object of the present invention to provide such a system that determines values for assignments, prices for trades, and then automates the labor assignment and trading process.

It is a still further object of the present invention to provide such a system that demonstrates a quick payback for customers and a high value for clients participating in the EBC in order to get a critical mass of participants, which will increase the utility exponentially for all members of the EBC.

It is a yet further object of the present invention to provide an electronic exchange method that transfers participant's workforce labor intra-facility or inter-facility.

It is a still further object of the present invention to provide an electronic exchange method that allows participants to bid for workforce labor in order to buy employees to fulfill staffing needs, essentially a call option.

It is a yet further object of the present invention to provide an electronic exchange method that allows participants to sell employees in order to offload overstaffing, essentially a put option.

It is a still further object of the present invention to provide an electronic exchange method whereby the optimal price for parties involved in the transaction is determined through a labor arbitrage process, thereby creating a maximum, mutual return.

It is a still further object of the present invention to notify participants electronically of all successful and/or unsuccessful bids.

It is a yet further object of the present invention to disintermediate temp agencies.

It is a still further object of the present invention to improve work force planning.

It is a yet further object of the present invention to improve long term labor cost efficiency.

It is a still further object of the present invention to provide an electronic exchange method that allows labor exchange transaction to occur via open networks.

These and other objects, aspects and features of the present invention will be better understood from the following detailed description of the preferred embodiment when read in conjunction with the appended drawing figures.

### BRIEF DESCRIPTION OF THE DRAWINGS

FIG. 1 shows a top-level overview of the general process in the arbitrage of labor resources.

FIGS. 2-4 show block diagrams illustrating an Electronic Business Community (EBC) and the arbitrage concept among them.

FIG. 5 shows a block diagram illustrating the process layers of the computer system at the Client.

FIGS. 6-7 show a block diagram illustrating the architecture of the computer system, including simplified examples of the client process versus server process.

FIG. 8 shows a diagram illustrating a possible staffing scenario at facilities within the Electronic Business Community, which then serves as the basis for the examples used in this document.

FIG. 9 shows a block diagram illustrating a possible scenario in determining the need for options and creating option order.

FIG. 10 shows a block diagram illustrating the option valuation process for the example used in the entire process illustration.

FIG. 11 shows a diagram illustrating the option valuation process and the way it harnesses Resource Configuration Cells.

FIG. 12 shows a diagram illustrating the option valuation process within the Resource Configuration Cells.

FIG. 13 shows a block diagram illustrating the determination of the desired price range of an option order.

FIG. 14 shows a flow chart illustrating the option delivery and exchange hub.

FIG. 15 shows a block diagram illustrating the option order matching process for determining potential deals.

FIG. 16 shows a block diagram illustrating the strike price negotiation process in terms of determining a bidder and asker to ensure that the transaction results in a more equitable return of value to each side.

FIG. 17 shows a diagram illustrating the process to determine the final strike price that utilizes the principle of ensuring highest, most equitable return on investment to both or all sides involved in a transaction.

FIG. 18 shows a diagram illustrating the deal determination process via optimization.

FIG. 19 shows a diagram illustrating the optimization process and its core technique.

FIG. 20 shows a flow chart illustrating the deal delivery process.

FIG. 21 shows a flow chart illustrating the execution of a deal.

FIG. 22 shows a flow chart illustrating the execution of a deal from start to finish from the perspective of the Facility.

FIG. 23 shows a block diagram illustrating the three (3) main process categories involved in performing labor arbitrage.

FIG. 24 shows an overview chart illustrating the input data required to enable the labor arbitrage process.

FIG. 25 shows a screen capture of a current Graphical User Interface (GUI) illustrating some of the key fields involved in accomplishing the labor arbitrage process, in this case Employee data.

FIG. 26 shows a screen capture of a current GUI illustrating some of the key fields involved in accomplishing the labor arbitrage process, in this case Employee Preference data.

FIG. 27 shows a screen capture of a current GUI illustrating some of the key fields involved in accomplishing the labor arbitrage process, in this case Employee Requests for Time Off data.

FIG. 28 shows a screen capture of a current GUI illustrating some of the key fields involved in accomplishing the labor arbitrage process, in this case Facility Staffing Levels Required data. Note that other Facility data will be useful to further improve the determination process.

FIG. 29 shows a set of screen captures of current GUIs/reports illustrating some of the key fields involved in accomplishing the labor arbitrage process, in this case the Work Schedule data.

FIG. 30 shows a set of sample files illustrating the data formats for an order and also for a deal.

### SPECIFIC DESCRIPTION OF THE PREFERRED EMBODIMENTS

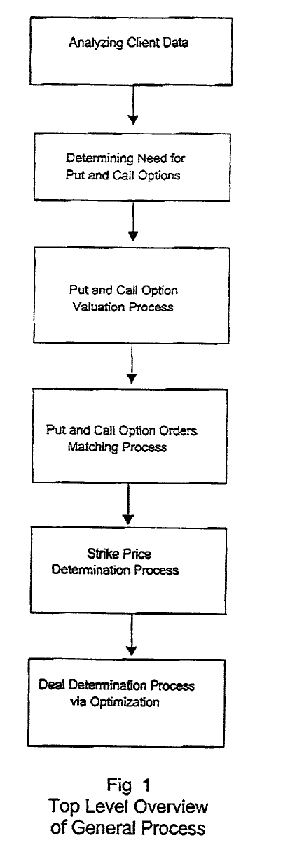

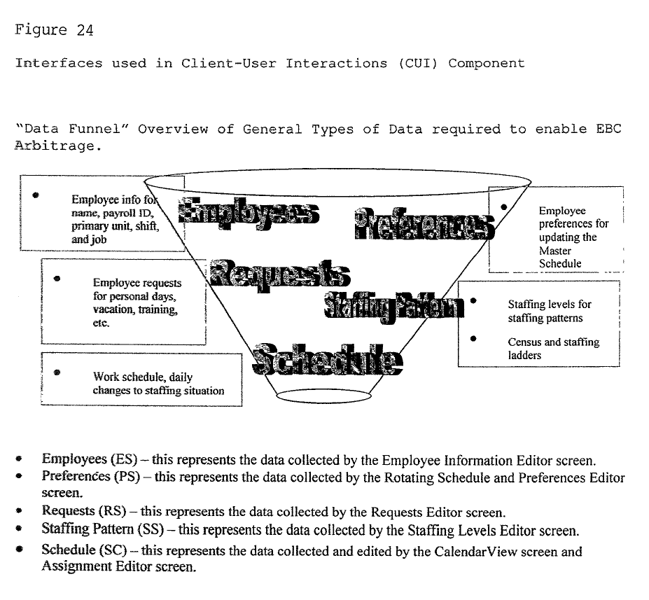

With reference to FIG. 1, the general Labor Arbitrage process is shown at a “birds eye” view. The various pieces of data that are captured from the client are depicted in FIG. 24.

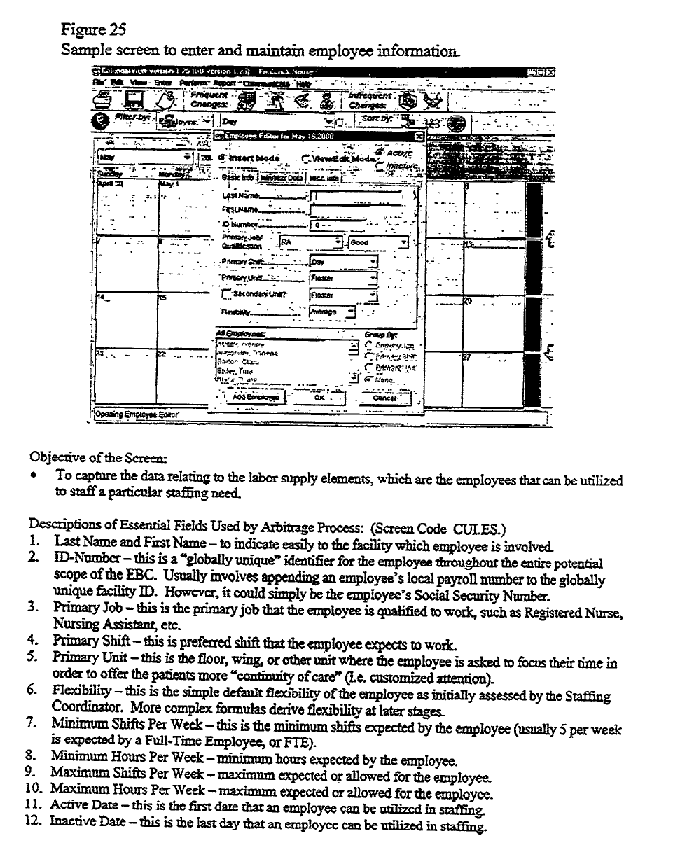

FIGS. 25-29 provide even more detail of the data involved in the process, showing the current Graphical User Interfaces (GUIs) that are used to capture employee and facility information, as well as view and modify the internal work schedules. However, the rest of this narrative describing the process focuses on just that—the process, not the data fields (since it assumes the data has already been stored in the database for retrieval by the process at each step).

FIG. 25 depicts a sample screen used to enter and maintain employee information. The screen captures data relating to the labor supply elements, in particular, the employees that may be utilized to staff a particular staffing need. The information that is entered on the screen illustrated in FIG. 25 is as follows:

1. Last Name and First Name—to indicate easily to the facility which employee is involved.

2. ID-Number—this is a “globally unique” identifier for the employee throughout the entire potential scope of the EBC. Usually involves appending an employee's local payroll number to the globally unique facility ID. However, it could simply be the employee's Social Security Number.

3. Primary Job—this is the primary job that the employee is qualified to work, such as Registered Nurse, Nursing Assistant, etc.

4. Primary Shift—this is the preferred shift that the employee expects to work.

5. Primary Unit—this is the floor, wing, or other unit where the employee is asked to focus their time in order to offer the patients more “continuity of care” (i.e., customized attention).

6. Flexibility—this is the simple default flexibility of the employee as initially assessed by the Staffing Coordinator. More complex formulas derive flexibility at later stages.

7. Minimum Shifts Per Week—this is the minimum shifts expected by the employee (usually 5 per week is expected by a Full-Time Employee, or FTE).

8. Minimum Hours Per Week—minimum hours expected by the employee.

9. Maximum Shifts Per Week—maximum expected or allowed for the employee.

10. Maximum Hours Per Week—maximum expected or allowed for the employee.

11. Active Date—this is the first date that an employee can be utilized in staffing.

12. Inactive Date—this is the last day that an employee can be utilized in staffing.

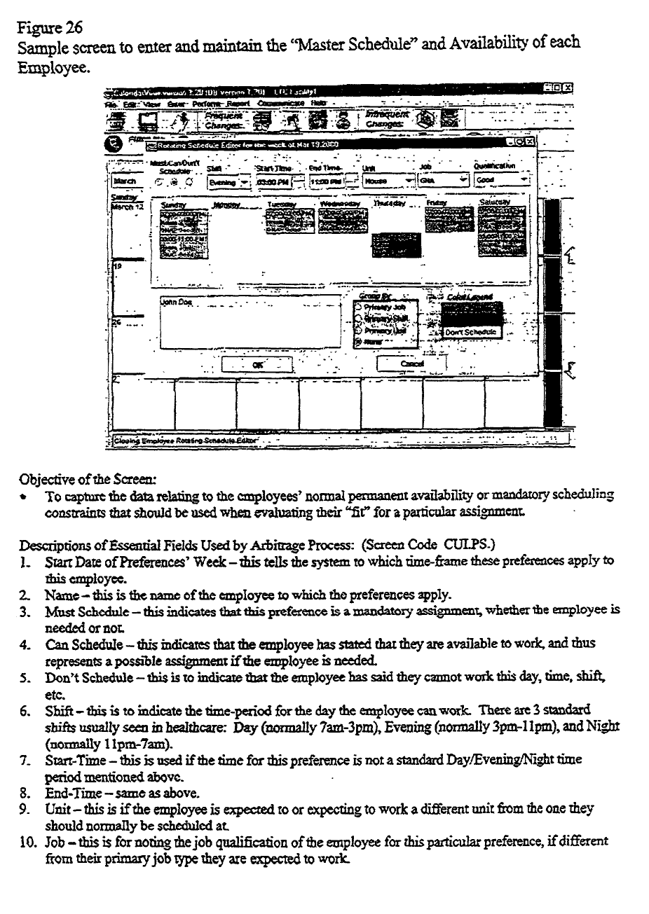

FIG. 26 depicts a sample screen used to enter and maintain a master schedule including an indication of the availability of each employee. The screen captures data relating to the employee's normal permanent availability or mandatory scheduling constraints that should be used when evaluating their fitness for a particular assignment. The pieces of information that are entered concerning this screen are the following:

1. Start Date of Preferences' Week—this tells the system to which time-frame these preferences apply to this employee.

2. Name—this is the name of the employee to which the preferences apply.

3. Must Schedule—this indicates that this preference is a mandatory assignment, whether the employee is needed or not.

4. Can Schedule—this indicates that the employee has stated that they are available to work, and thus represents a possible assignment if the employee is needed.

5. Don't Schedule—this is to indicate that the employee has said they cannot work this day, time, shift, etc.

6. Shift—this is to indicate the time-period for the day the employee can work. There are three (3) standard shifts usually seen in healthcare: Day (normally 7 am -3 pm), Evening (normally 3 pm -11 pm), and Night (normally 11 pm -7 am).

7. Start-Time—this is used if the time for this preference is not a standard Day/Evening/Night time period mentioned above.

8. End-Time—same as above.

9. Unit—this is if the employee is expected to or expecting to work a different unit from the one they should normally be scheduled at.

10. Job—this is for noting the job qualification of the employee for this particular preference, if different from their primary job type they are expected to work.

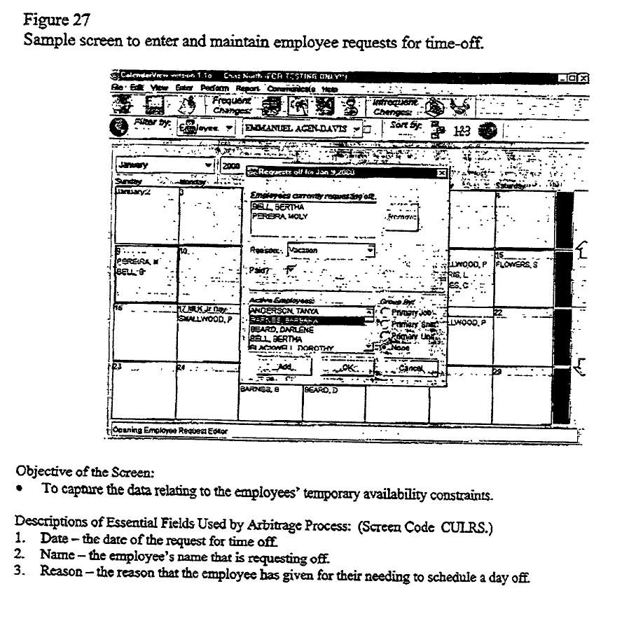

FIG. 27 depicts a sample screen used to enter and maintain requests by employees for time-off from work. This screen captures data relating to the temporary availability constraints of various employees. The information entered into the screen includes the following:

1. Date—the date of the request for time off.

2. Name—the employee's name that is requesting time off.

3. Reason—the reason that the employee has given for their needing to schedule a day off.

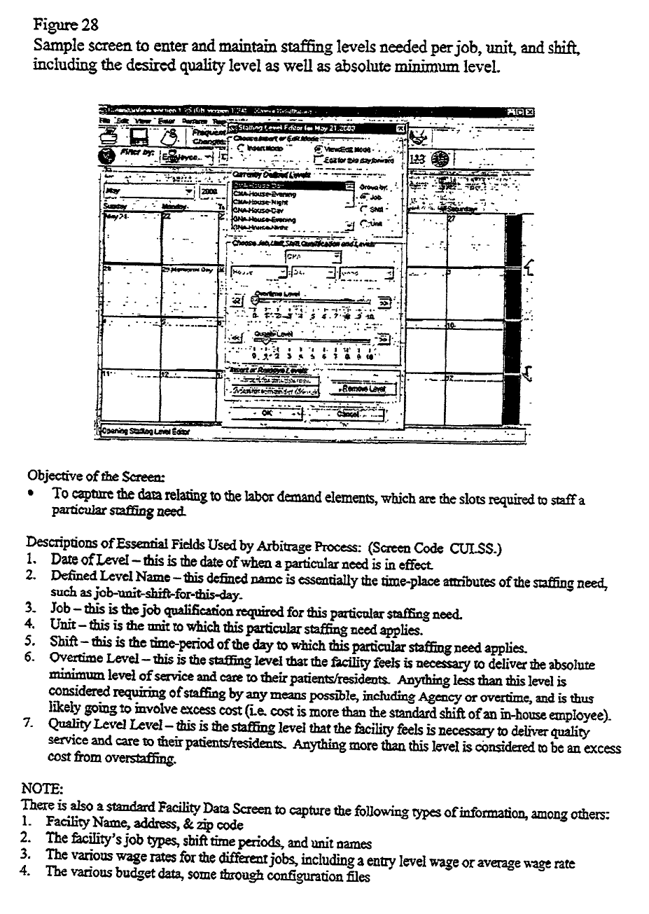

FIG. 28 depicts a sample screen used to enter and maintain staffing levels needed per job, unit and shift, including the desired quality level as well as the absolute minimum level of quality. The objective of this screen is to capture the data relating to the labor demand elements which are the slots required to staff a particular staffing need. The data entered when this screen is displayed includes the following:

1. Date of Level—this is the date of when a particular need is in effect.

2. Defined Level Name—this defined name is essentially the time-place attributes of the staffing need, such as job-unit-shift-for-this-day.

3. Job—this is the job qualification required for this particular staffing need.

4. Unit—this is the unit to which this particular staffing need applies.

5. Shift—this is the time-period of the day to which this particular staffing need applies.

6. Overtime Level—this is the staffing level that the facility feels is necessary to deliver the absolute minimum level of service and care to their patients/residents. Anything less than this level is considered requiring of staffing by any means possible, including Agency or overtime, and is thus likely going to involve excess cost (i.e., cost is more than the standard shift of an in-house employee).

7. Quality Level—this is the staffing level that the facility feels is necessary to deliver quality service and care to their patients/residents. Anything more than this level is considered to be an excess cost from overstaffing.

If desired, a facility data screen may also be employed to capture the following types of information:

1. Facility Name, address, and zip code

2. The facility's job types, shift time periods, and unit names

3. The various wage rates for the different jobs, including an entry level wage or average wage rate

4. The various budget data, some through configuration files.

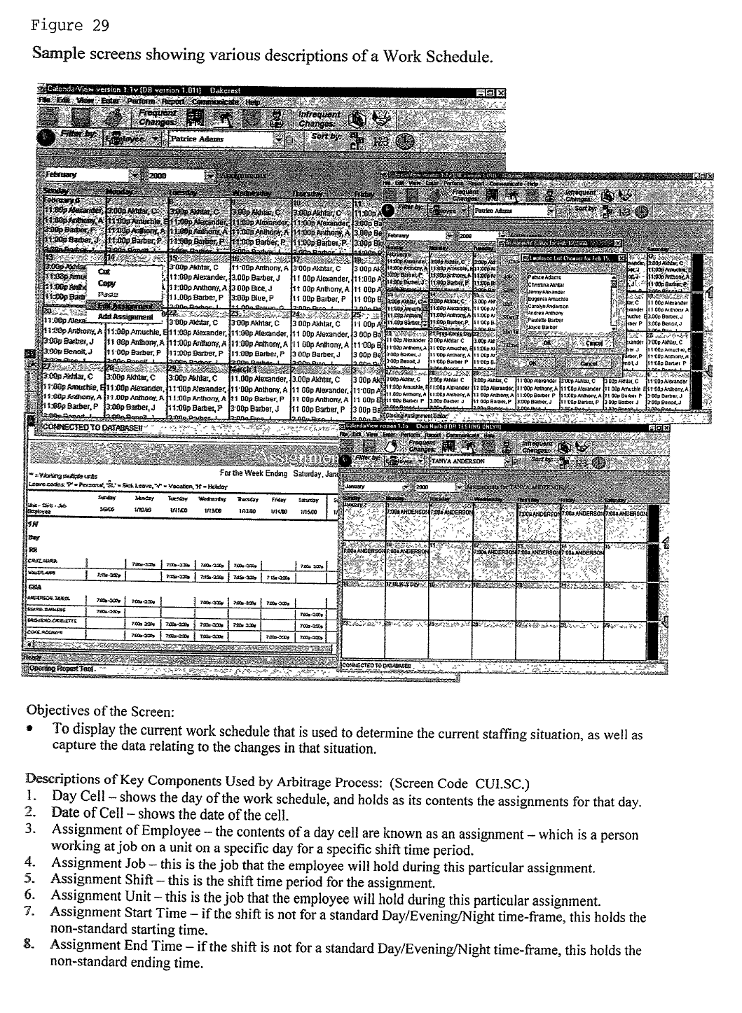

FIG. 29 depicts a sample screen showing various descriptions of a work schedule. The object of this screen is to display the current work schedule that is used to determine the current staffing situation as well as to capture data relating to changes in the current staffing situation. The key pieces of data captured when this screen is displayed include the following:

1. Day Cell—shows the day of the work schedule, and holds as its contents the assignments for that day.

2. Date of Cell—shows the date of the cell.

3. Assignment of Employee—the contents of a day cell are known as an assignment—which is a person working at a job on a unit on a specific day for a specific shift time period.

4. Assignment Job—this is the job that the employee will hold during this particular assignment.

5. Assignment Shift—this is the shift time period for the assignment.

6. Assignment Unit—this is the job that the employee will hold during this particular assignment.

7. Assignment Start Time—if the shift is not for a standard Day/Evening/Night time-frame, this holds the non-standard starting time.

8. Assignment End Time—if the shift is not for a standard Day/Evening/Night time-frame, this holds the non-standard ending time.

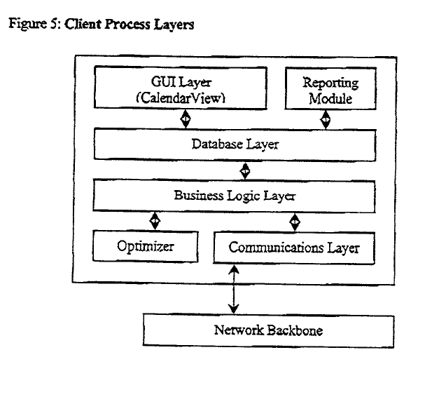

The output of the system tells users at the facility essential information relating to who is working, where, when, and how much they need to be paid and how much they will save as a result of utilizing them. The relational database is ODBC and JDBC compliant. The table structures and relationships are whatever is appropriate to minimize users redundant data entry, and to maximize conceptual simplicity and data integrity. This GUI data is stored in the database represented by a database layer in FIG. 5.

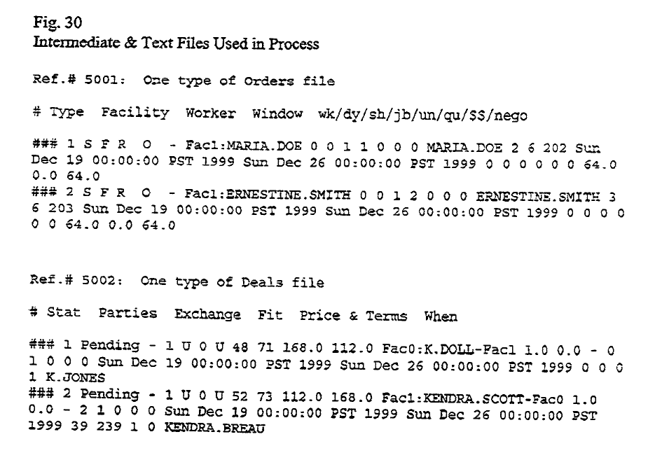

The GUI accesses the database via a Communications Protocol such as TCP/IP or TDS to enable its utilization on a network. This same approach applies to Reporting Module's access to the database. Note that some or all of the data could also be stored in a “flat file”, such as a text file containing columns and rows of data, such as the text file formats shown in FIG. 30.

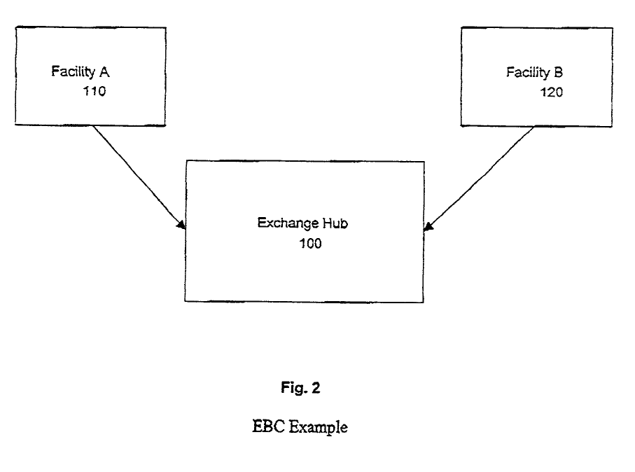

With reference to FIG. 2, the Labor Arbitrage process begins with an Electronic Business Community (EBC) of Healthcare facilities (110 and 120 in FIG. 2) considering the sharing and pooling of labor resources, perhaps in an effort to reduce the use of Agency. They are all connected to an “Exchange Hub” 100 via some type of electronic network that is used to combine their information, process, and return results to them.

More specifically, FIG. 2 illustrates the manner in which facilities within the EBC are interconnected. Facility A 110 and Facility B 120 are connected to an exchange hub 100. The exchange hub 100 is utilized to combine Facility A's 110 and Facility B's 120 information, process such information, and return results back to the facilities. The embodiment creates an EBC that allows facilities to exchange labor to improve some aspect of their business, such as, but not limited to, cost, quality, morale, or some combination thereof.

Each member of this EBC will have installed at its facility a software program that enables the performance of Labor Arbitrage.

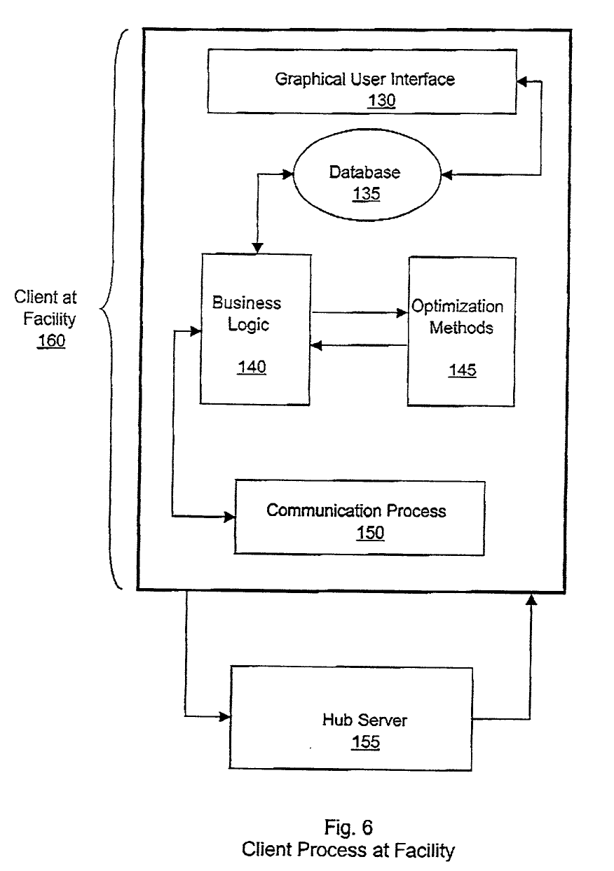

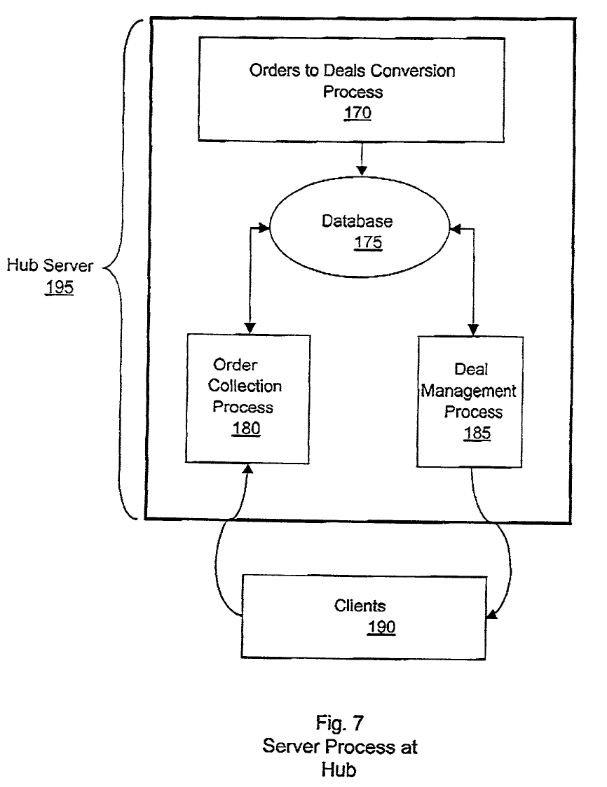

This means that, in Client/Server terminology, each facility 160 and 190, (FIGS. 6 and 7), is expected to do some of its own computations—thus being a “thick” client. Moreover, each facility is considered an independent entity, not reliant on the other facilities for any operational issues. Rather, they are simply “cooperating”.

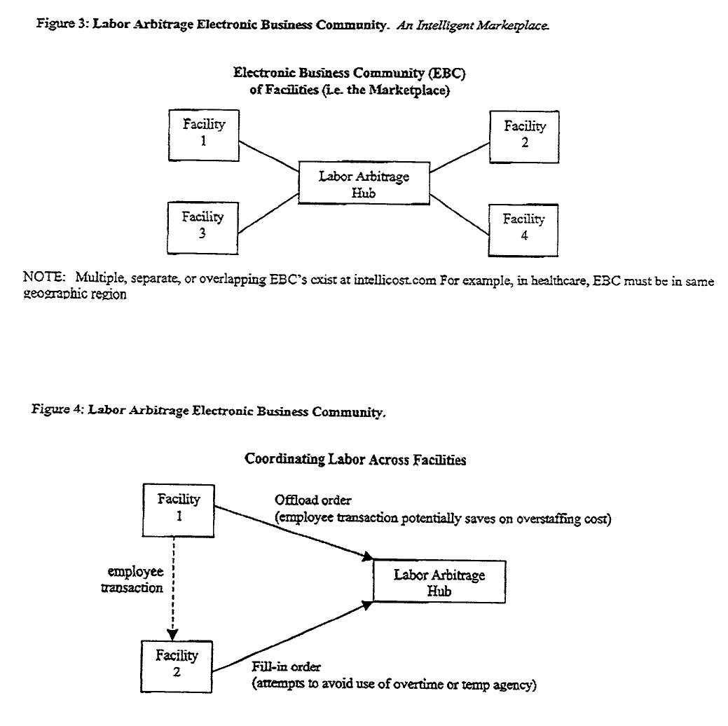

FIGS. 3 and 4 simply show more details on this concept, including that an EBC can consist of any number of facilities, and utilizes a conceptually straightforward mechanism for moving staff from one facility to another.

With reference to FIG. 6, the processes encompassed in the Thick Client include a User Interface layer 130, database 135, and Business Logic 140 necessary to develop questions and some answers for how to staff the facility. It also includes optimization 145 and communications 150 mechanisms to help obtain these answers.

With reference to FIG. 7, the processes at the Server Hub 155 and 195 are basically that of “order taker” 180 which are stored in a database 175. It also serves as a liaison to match two facilities that have complementary situations that give value to both sides 170. The hub can determine, by referencing a subscriber attributes list, the community of independent facilities that are willing to exchange labor resources and adopt employee actions that span across facilities. For example, certain community members may be willing to trade Rns, but not dietary staff. Or, facilities outside certain geographic areas may decide they are beyond reach for trading with each other.

The hub process also does a sophisticated negotiation process on each participant's behalf in an attempt to maximize the value they obtain—in effect, serving as an arbiter for each party, and being compensated as such. Once these deals are done, they are stored back in the database 175 for eventual distribution back to the clients 185.

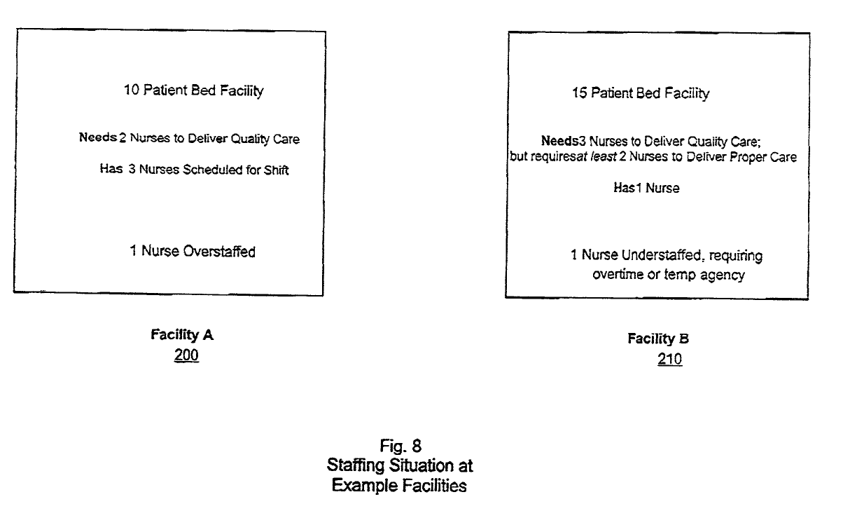

With reference to FIG. 8, the first step in the process to arbitrage labor is to have the technology assess what each facility has and needs, in terms of labor resources. This is done by taking the staffing plan (e.g., Work Schedule) and the staffing needs (in terms of Staffing Levels required for Quality Service Levels and separately the Staffing Levels required to avoid the use of overtime or Temp Agency staffing), and comparing these two items. That is, we compare the current staffing situations at each facility in the EBC.

For example, assume there are three (3) facilities in the EBC that want to participate in the labor arbitrage (Facility A, B, and C) . Examining Facility A's 200 work schedule, we see that on the coming Monday, they require two (2) Registered Nurses (RNs) to staff at a level that has consistently been necessary to provide quality service. However, due to an excess of RNs scheduled for that day (due to factors such as overhiring, employee preferences, etc.), there are currently three (3) staffed instead. On the other hand, Facility B 210, which is a larger facility in a more labor constrained neighborhood, has a work schedule that shows that on Monday they require three (3) RNs to provide quality service. However, they have also determined (based on the minimum staffing requirements mandated by the state, or perhaps instead on the insight of the Nursing Director) that they require at least two (2) RNs—which must be filled by overworking current staff or bringing in Agency staff. Consequences of not doing so range from reprimands by regulatory bodies, to turnover or injury of overworked staff, to law suits from mistakes/inadequacies resulting from insufficient staff.

Now, Applicants will commence performing the core of the “Labor Arbitrage” by developing put and call “option orders” for labor.

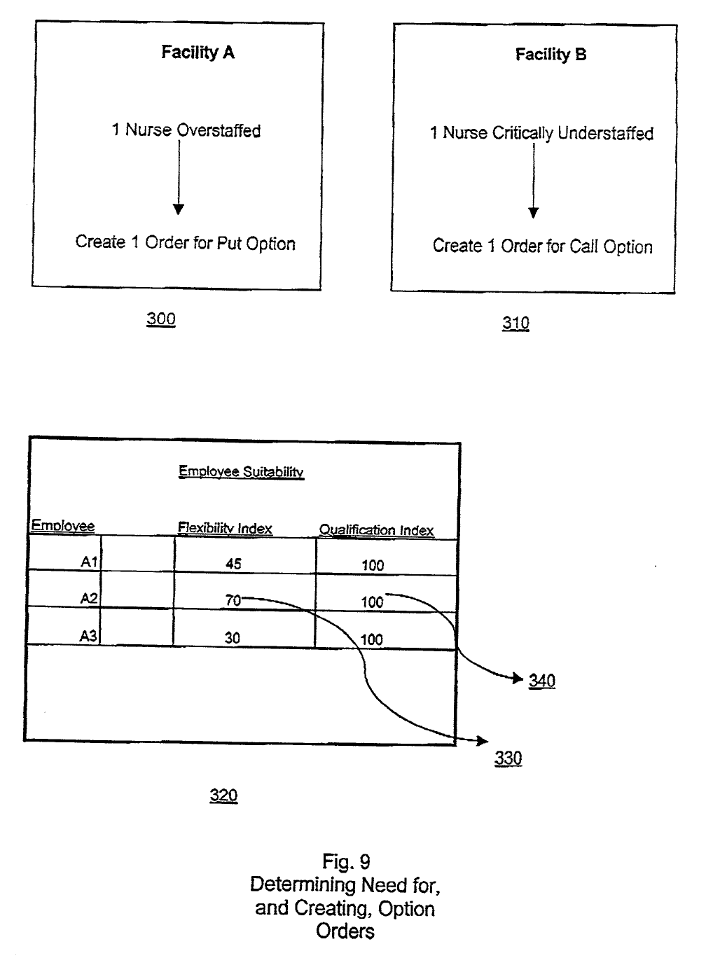

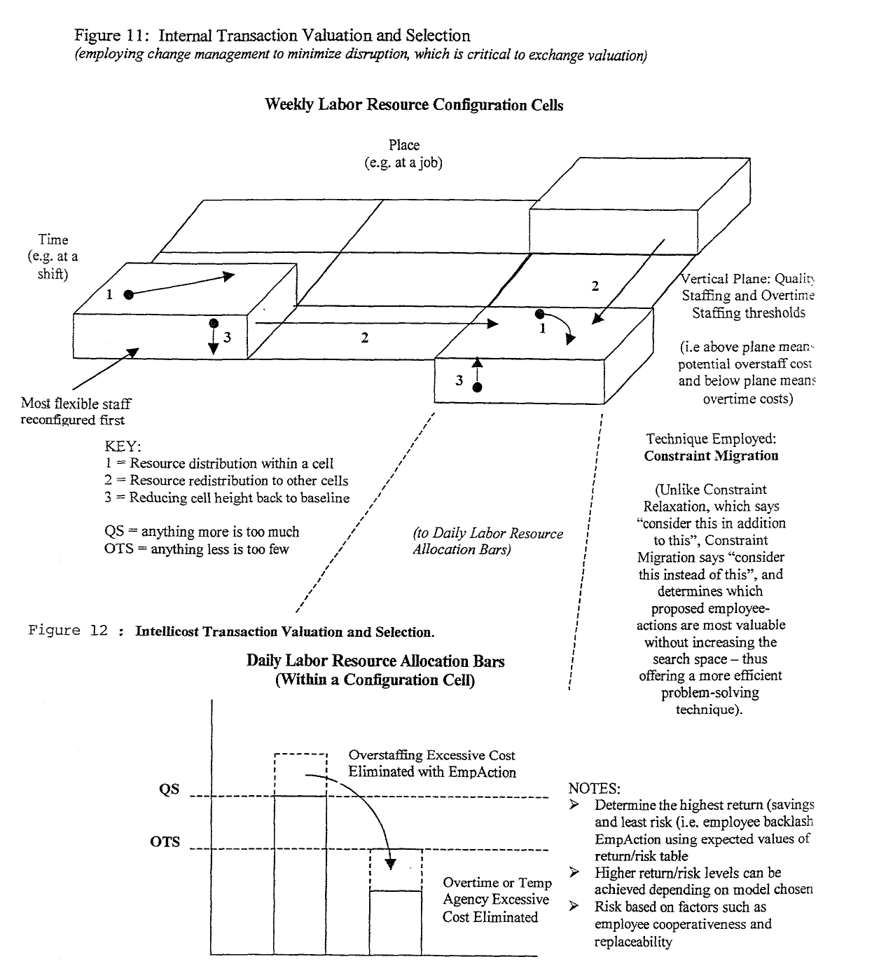

With reference to FIG. 9, Applicants derive the Put order at Facility A 300 by looking for those employees whose job and shift are in excess of the Quality Level throughout the entire facility. With reference to FIG. 11, the concept of a job-shift cell is discussed (and examined at a single day within the weekly job-shift in FIG. 12), wherein the facility's workforce is subdivided into labor resource configuration cells. Employees usually fall into these categories (e.g., RN-for-Evening-Shift, or RN-Evening for short), and it is generally difficult for them to move into (i.e., be utilized by) another cell. Therefore, if there is an overage in a job-shift, the excess employees cannot be moved into other job-shifts readily, and are hence overstaffed—even if there is understaffing in another job-shift. Accordingly, the same holds true of critical understaffing at a different job-shift—since it can't use the overstaffing from another job-shift cell, the facility either resorts to overworking (through overtime) the existing staff in the job-shift, or contracting out to other workers that meet the job-shift requirements, such as Agency staff.

Additionally, with reference to FIG. 9, Applicants next, with any Put order, must have an employee (i.e., the underlying asset in the arbitrage) to transfer. First, take all qualified 340 employees in this job-shift 320. Then, choose from them any with the highest assessed flexibility 330 to ensure the highest likelihood of a transfer taking place. Optionally, Applicants may tie to the order an amount of incentives required to ensure that the employee is willing to transfer (static figure, or can be 10-25% of savings value determined later). Once again, Applicants are finding the most flexible employee scheduled at this job-shift for assigning to this overage that Applicants desire to offload, and the employee must have the required job, skill set, availability, etc., to be considered as an acceptable transfer prospect.

Call orders are derived by looking through each job-at-a-shift, and seeing where the current staffing level is below the Overtime Level throughout the entire facility. State the qualifications necessary for any transfer to be accepted.

If Applicants look at the example, since Facility A is over its quality level by 1 (i.e., 2 needed vs. 3 staffed, means 1 over), there is 1 put option order created for offloading this overage. Applicants create these orders based on the assumption that there will be someone actually identifiable to be transferred. This means finding an employee with flexibility to increase the probability of the employee being willing to transfer, and perhaps at lower investments (such as lower incentives).

This flexibility assigned to each employee can be subjective (based on a rating from management), or more objective (based on quantitative and qualitative factors) . Moreover, the employee selection can be based on finding the best available flexibility in the job-shift cell (arbitrarily selecting in the event of tied employees), in which case an employee will always be found and thus put order completed. This is expected whenever a facility has hired employees specifically for their own Joint Float Pools of staff. Or, it may be based on a minimum flexibility threshold level, which may mean that no employees meet the minimum threshold and thus the put option order is canceled due to a lack of an underlying asset—there is no employee to transfer. Note that each employee's flexibility can also be derived by looking at what they would demand to go to certain facilities, or facilities with certain attributes, such as distance from their home, the work environment, etc.

In order to ensure that there is always an employee to transfer, employees may be promised incentives, on a range from 0-33% of the price of the shift. This allows the facility to compete against the Temp Agencies for scarce staff, as the incentives overcome the 10-15% premium workers get from an Agency over standard industry rates. For instance, if an employee is being used to cover for an overtime (OT) level shift at 50% excess cost, from an overstaffing (OS) level shift, at 100% excess cost, the math works out as follows. The shift would normally cost $160 for an RN, let's say. The Agency would thus offer $184 (i.e., 15% moe —for $24 extra in this case). But the OS savings would be $160, while the OT savings is $80, for a net total savings of $240. At an incentive rate of 20%, the employee would make an extra $48 —which is twice as much as they would make at an Agency. Furthermore, the facilities together still make 4 times that in savings (i.e., 80% of the total savings). For now, these incentives may be just cash, but later could be other, more intangible items, such as requests for time off, or working with people with whom they want to work.

In addition to the donor offload (of overstaffing) and recipient fill-in (for overtime/Agency) types of option orders, there are other option orders that can be generated and benefit the arbitrage parties:

Call Option Orders by Recipient Facilities (these are option orders that can “absorb” staff from a put option):

Quality-cover Call—this is for a facility that will likely not have to pay overtime or Agency costs since they are currently not below their overtime staffing level threshold, but they are still below their quality level, and would like to improve their service quality by getting more staffing.

Send-home Call—this is for an employee who is scheduled, but can be sent home, such as when they already have enough shifts or requested off for that assignment but could not get it granted. In other words, these are option orders that can “absorb” a put option.

Put Option Orders by Donor Facilities (these are option orders that can “contribute” staff to a call option):

Sign-up Put—this is for when an employee has not yet reached the max shifts he can work, although he is not scheduled to work anywhere.

Lean-staffed Put—this is for when a facility is not overstaffed in terms of being over the quality level, but rather can afford to give up an employee assignment to someone else because they are still over the critical staffing level of the overtime staffing level. It can also be used by facilities that are desperate to reduce costs to meet a budget while maintaining morale of staff that would otherwise not retain enough shifts for their pay or benefits.

It is also worth noting that there is another source of put options. The “free agents” (for example, contract workers) that could be participating in the labor market offer another pool of labor to draw upon for the EBC outside the current member facilities. Clearly, they must be part of the network in some way, whether the means of interaction be the phone, pagers, e-mail, Internet, etc. We define free agent essentially as an individual not currently an employee of a healthcare facility, but who is willing to offer a put option to fulfill a facility's call option for labor. These could be people who would normally be seen at Temp Agencies who want to maintain their independence from the facilities. This could be in order to maximize their options and/or pay for temporary employment opportunities.

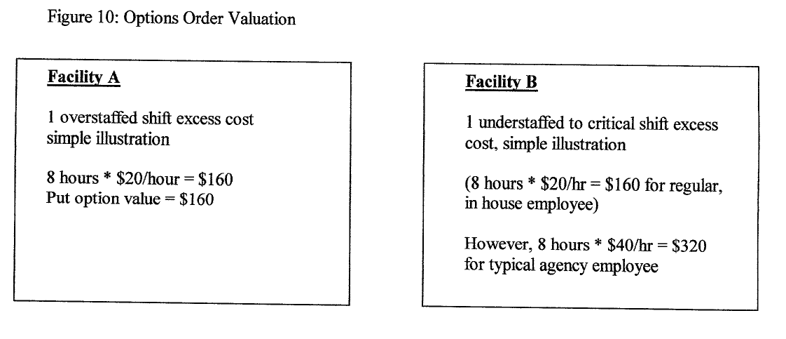

With reference to FIG. 10, valuation of orders will be explained. Once facility needs are determined, all potential employee actions (i.e., taking an employee and recommending doing something with him/her) are prioritized using two factors:

Size of return (cost avoidance in dollars, or dollars that can now be earned with this staffing)

Effort of change (based on employee flexibility metrics to qualitatively assess probability, including thresholds. Also, incentives required, and risk of no change).

The invention evaluates two issues relating to costs avoided—the type of cost, which includes overstaffing (requires offloading or give-ups) and overtime (requires filling-in or bringing in sign-ups or covering quality staffing level deficits), and then the magnitude of the cost which is measured in dollars. Note, however, that other costs (such as penalties for not having an assignment) could be considered in the future, as well as returns based not on costs avoided, but rather on earnings now possible given the staffed assignment. The technology will eventually also address cost overages caused by using overqualified staff, such as using a higher paid RN when a lower paid LPN would suffice.

The expected value of overstaffing factors is the probability that the job-shift cell of the currently overstaffed assignment will remain overstaffed. This can be influenced by the statistics of the employee or the assignment based on historical call-offs, as well as potential events that could have an impact, such as impending holidays or even upcoming music concerts. Thus, this probability can range from 0% to 100%, depending on models chosen for the type of facility that are based on statistical histories or predicted events, or could simply be subjectively chosen by the user and stored in a formula in the program.

The same type of logic applies to overtime or Agency returns on investment, wherein the probability of the staffing level remaining below the overtime staffing threshold is considered in the expected value. However, there is a twist here versus the overstaffing. It is very unlikely that if the overtime shift is unfilled currently that it will be filled without incurring the overtime or Agency fees, since in general the facility management would only run the arbitrage mechanism after they have exhausted all the lower cost alternatives. Furthermore, the facilities tend to be understaffed in general, so less staff is available without resorting to more expensive means. The twist is that there is a higher likelihood that the overtime staffing level as stated by the management could actually decrease (perhaps due to drop in patient census), in which case the management would let the level drop and thus not even fill the empty slot—thus saving money. However, given the consequences of running short-staffed, and their own experience which goes into their judgment of an appropriate overtime staffing level, this overtime/Agency cost probability still has a high probability. These return and effort results can then be placed in a table of employee-actions with corresponding ROIs (or a risk-to-return table).

Put orders are valued by calculating the cost of the overstaffing that results when more employees are staffed for a given job-shift than was actually needed. Calculation is simply the number of hours overstaffed which is then multiplied by the wage rate of the employee's wage, or job type's wage, if preferred.

Value the Call orders by calculating the cost of the overtime or Agency that results when fewer employees are staffed for a given job-shift than is minimally needed. Calculation is simply the number of hours under (the overtime level) multiplied by the overtime or Agency premium costs (50-100% of wage) of the job type.

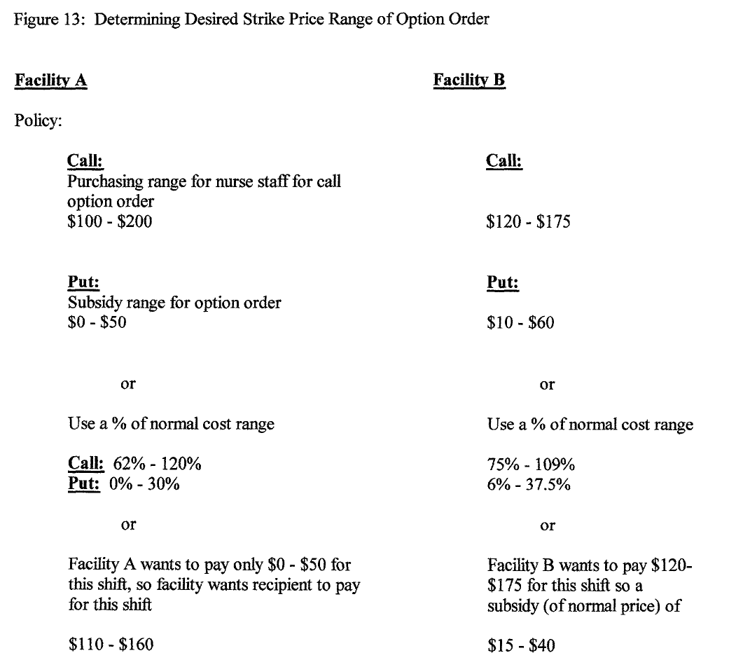

With reference to FIG. 13, now that the value to the facility has been derived from the expected value, it should now be seen that it is time to determine a “negotiating range” that the facility is willing to try and strike a deal. This range essentially states what degree of subsidization it is willing to do versus the “standard”, typical price of the labor assignment (the labor assignment is the underlying asset, so this standard price is termed “asset price”) for the type of employee in question (e.g., Registered Nurse). This range can be obtained in two ways. The first is to offer a subsidy based on an absolute number of dollars, and the second is to base it on a percentage. The percentage in turn can be based on the cost of a standard shift, or can instead be based on the expected value of the return on investment of the assignment. Ultimately, the user can specify numbers, or have the system rely on a formula.

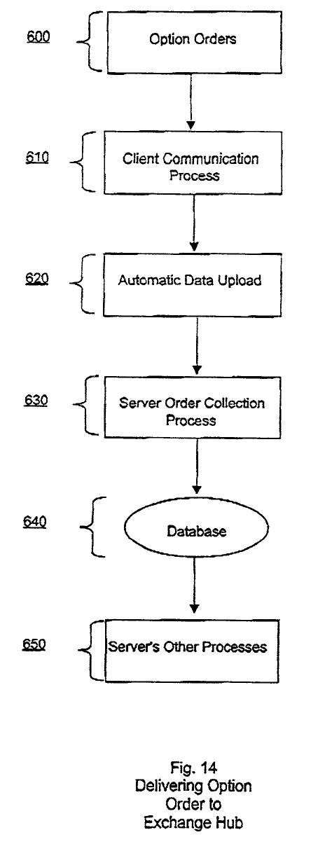

With reference to FIG. 14, it is now time to send these option orders 600 to the Server at the Exchange Hub. Assume a facility is using the inventive application. After computing the information relevant to inter-site resource sharing, the application connects via Communication process 610 to the server's relational database via a Java database connectivity mechanism known as JDBC. This is possible because the server IP address will be static, hence the address is known. The application will then simply write records with the information into the database 620 via SQL statements. This will work even if the clients are behind a firewall, since typically firewalls allow connections out (although not in).

On the Exchange Hub side, the server will poll its database every N hours looking for information 640. When new data arrives, the relevant “get orders” process starts 630. As it is known, when clients update the database (based on their sign-up information, or statistical patterns), one waits until there is a high probability that the database information is stable and won't be asked to change while processing 650 takes place. Then, the database 630 is locked so no clients can change information while processing takes place.

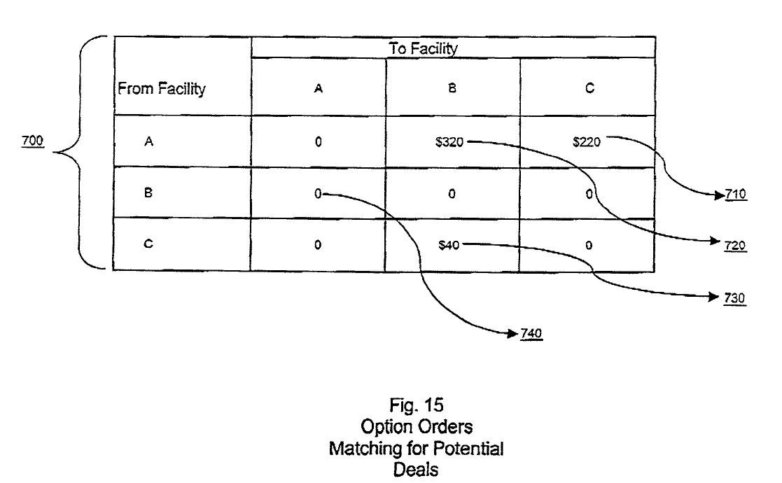

With reference to FIG. 15, once these orders are at the Exchange Hub's server, it is time to try and strike deals. Here, a table of exchange values is developed for all the potential deals between all parties in a two-dimensional table. As seen in FIG. 15, the From Facilities are the ones with the Put options (i.e., that are capable of being donor facilities). The To Facilities are the ones with Call options, intending to become recipients. Note that the table could also be three-dimensional to enable three-way deals, or n-dimensional for n-way deals. The technology intersects the needs of the facilities and determines the “best” deals.

The best deal maximizes the value to both parties involved in the transaction. The principle is to make sure the party that will likely get less value (e.g., save less money) will at least get closer, if not over, their asking price to undertake the deal. More specifically, the asker is given the most favorable terms that still fall into the bidder's acceptance range.

This strategy allows the system to keep all parties happy and returning to the community, which will increase overall participation and ultimately the utility value to all the members due to the “network effect” that leads to exponential increase in usefulness of a network as more people join the network. To illustrate, think of how much more useful the telephone is when you can call all people with phones, rather than if just one person in the whole world had a phone.

The initial goal of the strike price mechanism is to maximize the value of the asker to keep them returning while growing the EBC. The eventual goal, however, is that once the EBC size matures, a return can be derived from taking discrepancies in the negotiating ranges of the bidder and asker that offers a more favorable alternative business model for the present invention.

Accordingly, the “spread” can eventually be taken in order to avoid charging the facilities not only transaction fees, but even subscriber fees. However, in this scenario, the value to the asker is always less, and our EBC risks losing this member's participation—and thus their future offerings. This potentially impacts the “liquidity” of the EBC, and thus the overall utility and value in the short term. However, as the EBC reaches maturity, the value will be sufficiently demonstrated to retain all participants.

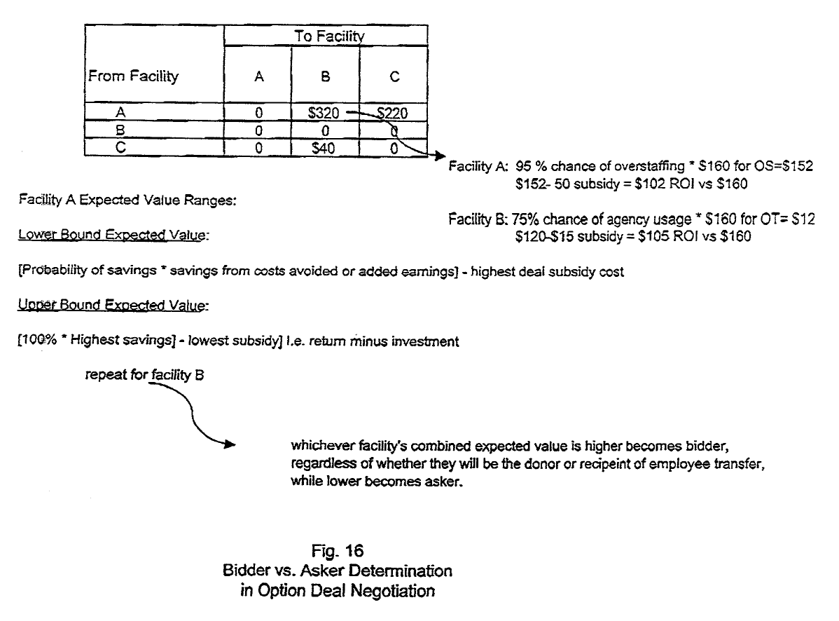

With reference to FIG. 16, maximum value is determined by which party will benefit more from the deal. This value is calculated by the expected values of: (expected return of the employee action)−(risk and expected cost of or investment for the employee action). The party that could gain the higher value becomes the bidder for the proposed action to take place and deal to be struck. The party gaining the lesser value becomes the asker.

To illustrate, in our example, the lower bound of the ROI is the point where the donor facility gives its highest subsidy to help the deal “happen”, while the recipient's is where it pays the highest premium for the employee assignment that it is trying to obtain. Conversely, the upper bound of the ROI range is where the subsidy or premium is at its minimum possible value. Now, since Facility A's ROI is higher than Facility B, it becomes the bidder in the negotiation, since it appears it will benefit more and thus should want the deal more.

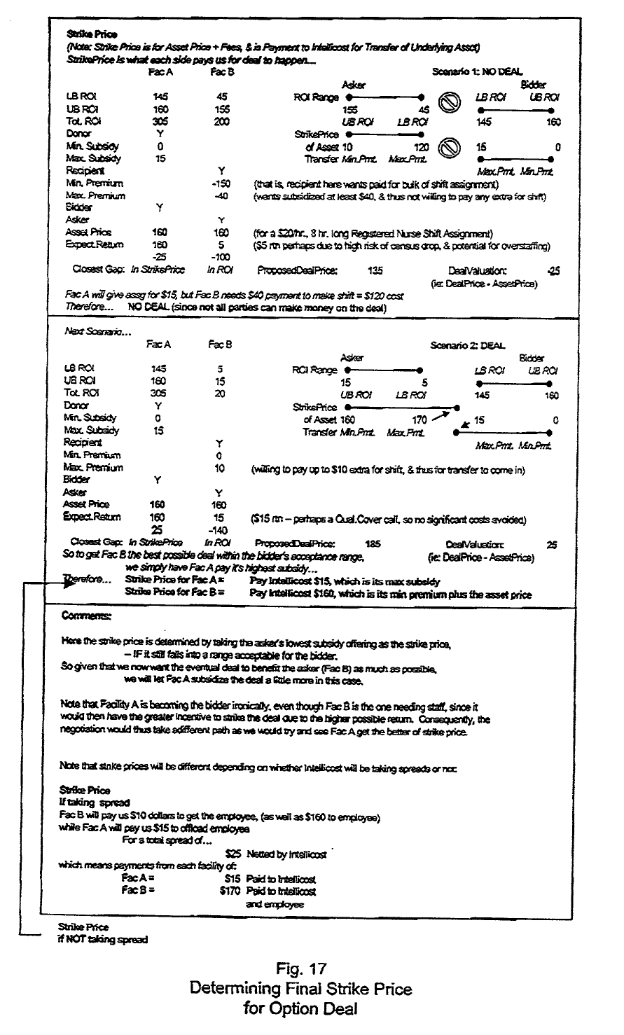

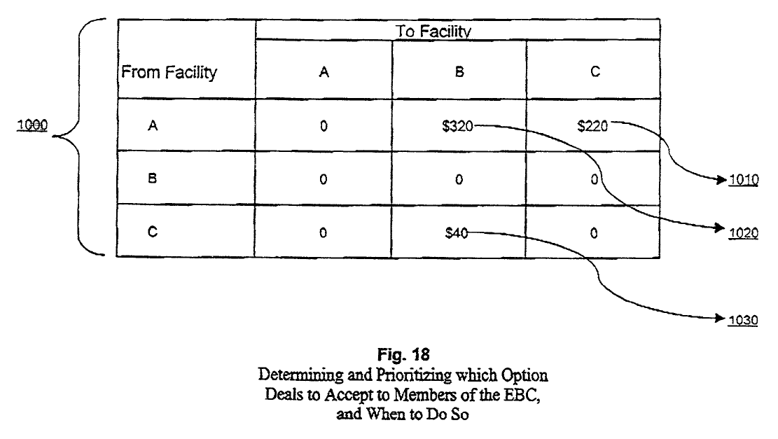

With reference to FIG. 17, we note that once again, the deals are closed at the highest asker value that falls into the bidder's acceptance range. For example, if we look at Scenario 2 of FIG. 17 (which shows the details of a viable deal to transfer an employee from Facility A to Facility B), the “desire” level that Facility A has to offload (through a put option) its overstaffed employee is represented by the $15.00 it is willing to pay in subsidy to offload the employee. Facility B which is willing to take on the employee's pay to fill a quality staffing level need is not going to get too much value, though, from the deal. Therefore, the acceptable range for the bidder (Facility A) is a subsidy of $0 to $15.00, while the asker (Facility B) has a price range in which it would be willing to pay $160.00 to $170.00 for the employee. If Intellicost is not seeking “spreads” revenue, then Facility B will get the asset for the ideal price it requested ($160.00), while the more “fortunate” participant of the deal, the asker (Facility A) will give its maximum subsidy that still falls within its acceptable subsidization range, in this case, $15.00.

Thus, a deal could be closed in the arbitrage process at an even lower price than a party's lowest bid if that party has become the asker, which happens when the deal is worth more to the other party. In essence, Applicants have created an Intelligent Marketplace.

The core objective of this part of the process is to ensure Applicants guarantee that both sides should make money, and as nearly equitably as possible to keep the EBC growing initially, and once the EBC is mature, allowing Applicants to take the spreads. FIG. 17 basically shows two examples—a “No Deal” versus a “Deal” set of scenarios.

Applicants define the strike price as the amount each side has to pay Applicants, since Applicants are serving as the clearinghouse, and this is the way Applicants ensure that they can take spreads in the future. It is assumed, for simplicity's sake, the Recipient of the employee assignment will be the one to pay the asset costs. The strike price is thus, for the Recipient, the underlying asset's price+some premium amount for the shift, unless the premium is not necessary, or the shift is subsidized by the offloading facility. However, in the case of the Donor, they just pay the subsidy in their strike price, since they should not be paying the employee. If a deal is done, it assumes that both sides must get some return, and that Applicants should also attempt to take a spread to help cover costs of the transaction. If the subsidy from the Donor turns out to be zero as does also the premium willing to be paid by the Recipient, then no spread will be taken.

It should be noted that the return can go up through infinity (such as if a facility were to avoid the cost of being shut down if it does not staff appropriately), but the subsidy and premium that a facility would have to pay would be capped by them. Strike price is determined from intersection to derive investment (subsidy, premium, and asset value) from the ROI—data of the ROI stored in the potential deal's fields.

Note that although Applicants' examples present only if the underlying asset's price is the same at both Donor and Recipient facilities. However, even if there are differences in the underlying asset's presumed or established value, this is not a dramatic change. Applicants would simply have the facility where the asset is priced lower offer the difference as a subsidy in its price range if it is the Donor. However, if the facility where the asset is priced higher is the Donor and the lower priced facility is the Recipient, the difference becomes a premium that A must pay to get B's employee. To illustrate, let's say Facility A pays a Registered Nurse (RN) $20/hr., such that a typical 8 hour shift costs $160. Now, if Facility B pays an RN $22/hr., (whether it be due to the facility's wage scale for RNs, or because the specific RN is simply paid more due to such items as seniority), its cost for the underlying asset−the employee assignment−would be $176. If Facility A were the Donor and Facility B the Recipient, and thus the employee transferred from A to B, the $26 difference is considered a subsidy that Facility A provides to Facility B, and would be factored into the price range of the option order. Conversely, if the employee were instead transferred from B to A, the $26 is a premium that Facility A must pay to get B's employee.

Once a closing price of all proposed deals are finalized, the system ranks the paired-order deals and prioritizes them based on urgency (i.e., time till expiration) by factoring this into the Return on Investment. More advanced trading options exist if, instead of pairings (or simple two-way deals), exchanges involving three parties or more (e.g., three-way deals) are considered for their potential cost avoidance returns.

Now let's consider more complex trades and exchanges, such as three-way, or even n-way, types of deals. Applicants use “adjacent” job types or zip codes as examples (think of a Venn Diagram of three overlapping circles of three different zip codes or job types; then imagine facilities inside each). If a Facility A needs to “put” an RN that lives in one geographic area (zip code 11111), but no adjacent facilities (in zip code 22222) have a “call” option that will pay them any value, a deal would seem unwise. However, there still may be a way to have Facility A offload an employee to Facility B in zip code 22222 and have it be of value to both facilities. If there is a Facility C with a call option of significant value in a zip code 33333 that is adjacent to 22222, but not to 11111, then the deal makes sense. This three-way deal requires a three-dimensional table of put-to-intermediary-to-call-facilities (in fact, an n-way deal would simply be an n-dimensional table) of expected values of ROIs to consider via optimization to select deals. Imagine a Z axis on FIG. 18 for “in-between” facility or “bridge” facility. However, this should only be done if the facilities are willing to face the trade-off of complexity (and Applicants are willing to accept greater time and computing resources for computing) of three-way deals.

Another scenario may involve having two facilities trading an RN Put from Facility A for an LPN call from Facility A to save money. Applicants do this as well as using an intermediary, in this case Facility B. That is, RNs might be desired at Facility B due to regulatory requirements, while LPNs are wanted at Facility A due to their scarcity and the RN cost considerations. Thus, Facility B's LPN pool might serve as an intermediary for Facility A to get back an LPN for the RN it offered. To help illustrate this more complex situation, Applicants could add to the mix a Facility C in a neighboring zip code that has one “trade-able” Nurse, one short on a Nursing Assistant, and perhaps want to replace an LPN with an RN due to regulatory requirements. For instance, one reason is that only an RN or higher can pronounce someone as deceased.

With reference to FIG. 18, the best deals are chosen via an optimization method, such as gradient descent. That is, once all these possibilities are laid out in the two-dimensional table, the optimization can gradually “close” (i.e., convert these deals into tentative contracts in the manner known as hill-climbing—wherein Applicants simply choose the deal with the highest ROI at each iteration).

Thus, Applicants first choose from an example the Put of Facility A applied to the Call of Facility B 1020. Once a deal is closed, the orders involved in that deal are removed from the table and thus from further consideration from other possible deals, thus precluding the formation of a deal from Facility A to Facility C 1010. However, Applicants could choose the next lower deal still possible 1030. These deals become the basis for exchanges between the facilities.

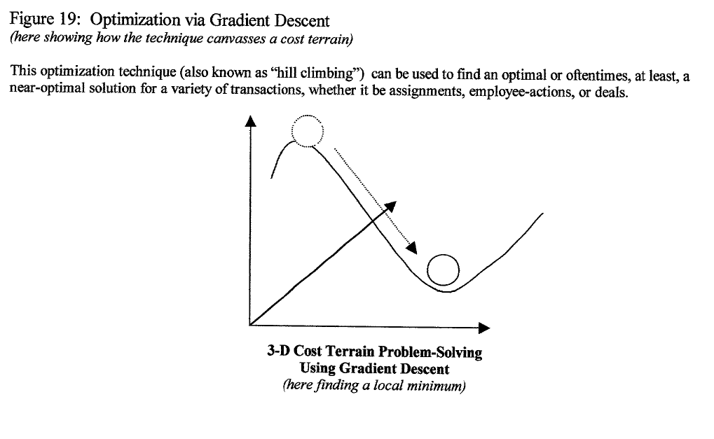

With reference to FIG. 19, the optimization is used to achieve fully acceptable output information within reasonable performance bounds for all the problems being solved. The optimization technique must develop solutions as good or better than a skilled human could, and in a time-frame as good or better than a human could accomplish for the same feat. This is the premise of using gradient descent (i.e., “hill climbing”) for pruning the search space for solving the problem set. FIG. 19 shows the conceptual example of a gradient descent mechanism—it simply rolls down a cost terrain until it has found a minima, whether it be local or absolute.

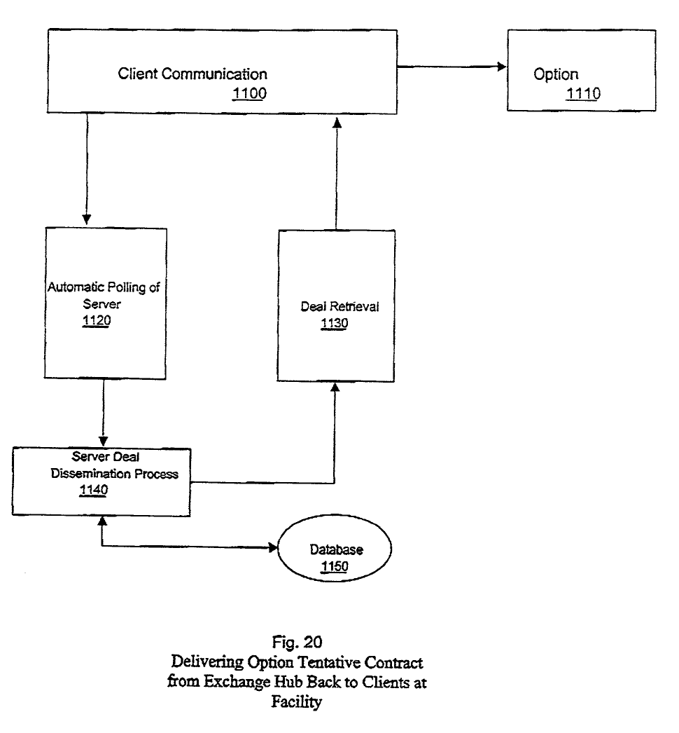

With reference to FIG. 20, after the Server's Orders-to-Deals process is done processing, it initiates the Deal Dissemination Process 1140 which in turn sets “flags” indicating to the facilities' client processes (the next time they connect to the server) that they need to download data from the server. (However, the server can send an e-mailed message to client once deals have been created in order to simplify the initial implementation, rather than client polling server.) The flag will be a database field so it will be JDBC accessible, as will the data relevant to the client 1130. This scheme requires that the client process 1100 poll the server 1120 for data updates, which although not ideal, shouldn't be that much of a burden for the client. The client can poll before running the present invention application each day. If client-side polling is not desired, the server can write data to the client databases, also via JDBC. However, this will probably not work if the clients are behind a firewall. There are synchronization issues involved in the asynchronous way orders and deals are manipulated, but these issues have been handled by simply checking the time stamps on the orders and deals at each stage in the process to see if there are more recent orders that would supercede a current order under consideration. Finally, the potential exchanges shown in the tentative option contracts are sent back to each facility 1110 involved for execution (approval or rejection).

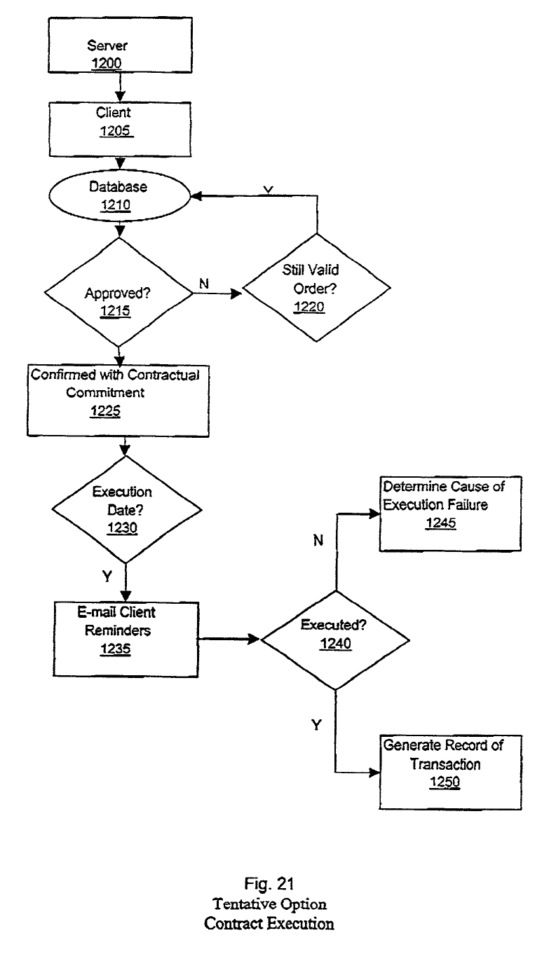

With reference to FIG. 21, once the server process 1200 returns the deals to each of the relevant clients 1205 that are involved in the deal, they are stored back in each facility's database 1210. The details of the deals (including the Facility, the Employee involved, and the date and time of the assignment, as well as job/department/skill set) are displayed to the user at their next login to Applicants' system, or alternatively e-mailed to a manager at the facility.

Here, the facility's users (i.e., management) can decide 1215 whether to approve or reject the deal. If the deal is accepted first by one side 1225, it must be accepted by all other sides before it can then be automatically incorporated into a staffing plan or schedule. If approved, a confirmation can be sent to other parties involved through the hub.

If rejected, the orders involved in the rejected deal are “freed” to possibly be used in other deals, if it is still a valid order 1220. If the order is no longer valid (e.g., due to member removal from EBC, or expiration of order), then the order is simply discarded by not loading it back to the database. Once approved by all, incorporate into staffing plan/schedule the new assignment added (if this facility is a recipient), or the assignment removed (if the facility was a donor). Here lies the ultimate results that Applicants see in their process—an employee transfer, which can then benefit the key facility performance facets of cost, quality, and morale.

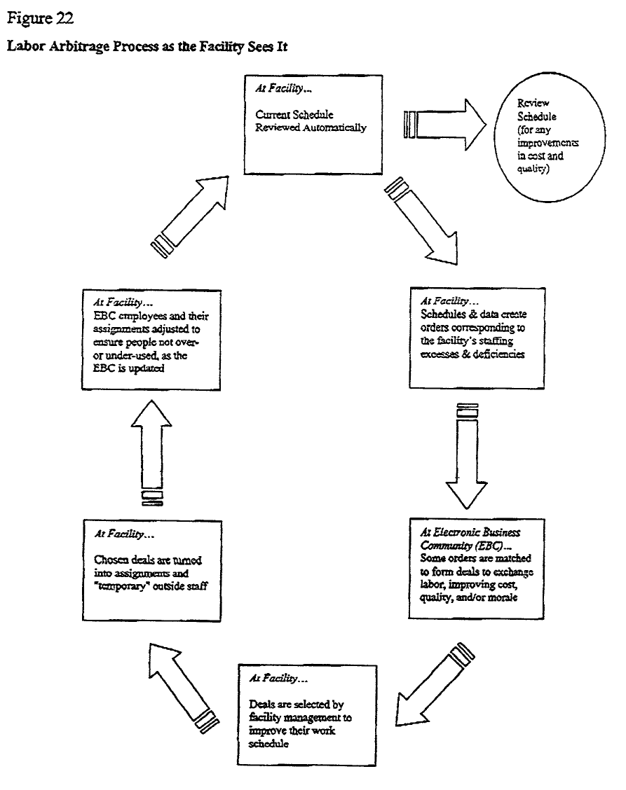

FIG. 22 recaps the overall process, but this time from the perspective of the facility, which is primarily concerned with improving their staffing as depicted by their work schedule.

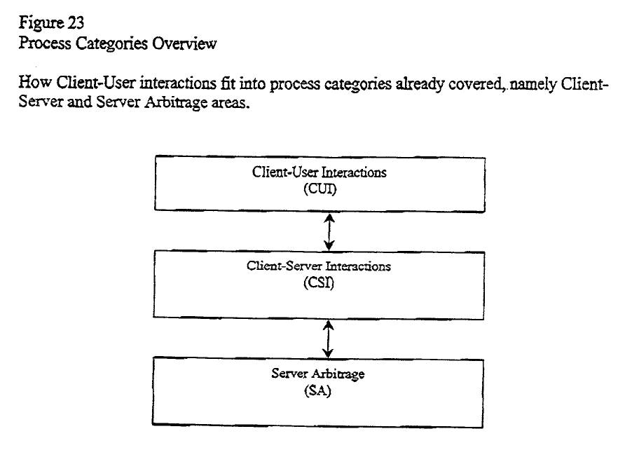

FIGS. 23-29 simply give details of the key data required by Applicants' system, and the input screens that can be used to capture this information, although other input screens can also be used in addition to or in lieu of the ones shown. FIGS. 24-29 have been explained hereinabove in detail. FIG. 23 is self-explanatory.

Applicants have developed software which is used in practicing the teachings of the present invention. One example of a manner of operating such software to conduct the inventive process is the following:

1. Facility enters in employee information (such as employee ID, shift and schedule time, wage rate, flexibility, vacation requests, other requests) and potential rules and guidelines for these resources, and this information is stored in the database.

2. Decision Recommendation System (DRS) develops the initial facility work schedule based on current supply and demand of internal facility resources (with initial optimization, not incorporating recommendations).

3. DRS at periodic intervals determines and delivers potential options/recommendations to facility user to further optimize facility work schedule with internal facility resources using both short-term and long-term recommendations to work schedule.

4. Valuation component in Labor Exchange process evaluates facility work schedule created by DRS and potential revised versions after recommendations instituted from DRS recommendations, and evaluates the potential inefficiencies still in the work schedule for facility that could only be solved with external resources. Then, the Valuation component derives facility orders with the intent of solving these problems using external resources.

5. Arbitrage Hub component ongoingly cross-references orders received from all facilities at the server and develops and delivers potential deals to facility user that would allow facilities to further optimize work schedules using the resources available from other facilities.

Rather than absorbing unnecessary staffing resources (and hence associated staffing costs) and/or seeking temporary resources from temporary staffing agencies (at significantly higher costs)

It is instructive to understand, within a labor process overview, the distinction between a “Thin Client” and a “Thick Client”. The distinction is as follows:

Thin Client: All the data is written to and read from the same place (directory) on the same machine (server) and thus all orders and decisions are created and stored at the server. Facility user accesses the orders on the server via the network and GUI.

Thick Client: All the data is written to and read from folders across client applications (since each client facility has local copies of data and workflow automation tool). Thus, orders are created by Valuation component at the client, then they need to go to Arbitrage Hub, then they need to get back from Arbitrage Hub to client.

1. Valuation component develops orders for Labor Exchange process;

2. Task Scheduler component will run periodically (as determined by the user) and then automatically attach to an e-mail message containing the order that gets sent to the Arbitrage Hub at the server;

3. Once the message arrives at the Arbitrage Hub, the attachment containing the orders is written to a central directory waiting to be processed;

4. Once processed by the Arbitrage Hub (process of cross-referencing all orders from all facilities to see if any potential deals can be created), orders that were involved in deals are sidelined (to avoid being involved in other potential deals) until the deal is either accepted or rejected;

5. Deals are then attached in an e-mail at the Arbitrage Hub and sent to the respective clients, whereupon, the files is written back to a directory to await review by the client;

6. If a deal is approved by the client, the approved deal is sent back to Arbitrage Hub (via same e-mail process as orders are sent) in order to purge order from system and update. The Arbitrage Hub then sends a confirmation e-mail back to the participating facilities confirming the deal;

7. If a deal is rejected by the client, the rejected deal is sent back to the Arbitrage Hub (via same e-mail process as orders are sent) in order to reinstate the order back into the general Arbitrage Hub order pool (unless order has expired, or is overridden by another order).

6. If potential deals created by the Arbitrage Hub component are accepted by facility user, Arbitrage Hub will communicate updated plan to participating facilities (as explained in paragraph 5 above) and current work schedule will be updated to incorporate the accepted orders.

7. Facility users can retrieve valuable facility specific or enterprise-wide (if facility users happen to be corporate management) information created by Knowledge Transfer process.

The inventive process is not limited for exclusive use in the healthcare industry. The disclosed labor exchange process can be applied to any entity using assignable labor resources, where similar labor resources (with similar skill sets and qualifications) from similar entities are available and transferable. To enable an entity to utilize the teachings of the present invention, the following parameters must be achieved:

(1) All entities involved in the exchange process have a means to enter in and store labor resources information.

(2) Assignable by definition could entail a labor resource assigned to an entity for a work shift (e.g., Monday night shift), project (e.g., construction of building Y), or time frame (week of October 6^{th}).

(3) Examples of many industry applications outside of the spectrum of healthcare continuum of care for which a need for the process of labor exchange is present include the following:

QSR (Quick service restaurants) employees (e.g., McDonald's®, Wendy's®, Burger King®)

Airline employees (both flight crews and ground based staff)

Hotel and motel service staff (including maids, housekeeping staff, bellboys, maintenance staff)

Traditional retailers (e.g., department stores, discount retailers, grocery stores, traditional restaurants, mall-based retailers, movie theaters)

Construction employees and general contractors

Auto body shop employees

HVAC employees (residential and commercial heating ventilation and cooling service personnel)

Electricians and plumbing service providers

Gas station attendants

Security firms

Programming shops

Any entity in the aforementioned industries could benefit from the labor exchange process disclosed herein for two fundamental reasons:

(1) Having the ability to electronically and automatically cost effectively obtain similar, qualified labor resources to: fill short-term demands, maintain quality staffing levels, and/or avoid costly temporary staffing firms;

(2) Having the ability to electronically and automatically cost effectively offload unrequited, similar, qualified labor resources to entities that could more cost-effectively utilize them in the short term (and are seeking to do so) to avoid unnecessary overstaffing (and the associated costs associated with it), or to enable them to meet mandated or desired budgeted staffing targets.

I. The present invention comprises a valuable business tool for the following reasons:

1) Makes Staffing Easier to Manage—reduces time, effort, and risk (of not doing the right things) involved in staffing.

2) Keeps Current Staffing—reduces turnover and call-offs through Change Management, Master Schedules, and other morale enhancements that improve staff retention.

3) Finds New Staffing—pools resources with other facilities (i.e., cooperate rather than compete), identifies candidates, then attracts those that best fit needs with incentives.

4) Makes the Most of Current Staff—motivates targeted staff toward a FlexPool with incentives, then uses this FlexPool to improve efficiency.

5) Technique Employed—Pareto's rule (the 80-20 rule) to obtain 80% of the benefits with just 20% of the staff, focusing incentives just in those 20% with flexibility and that yield the high degree of savings. Claim: Maximizes benefits while minimizing risk.

6) Technique Employed—The value increases according to Metcalfe's Law (the Network Effect). Example, the telephone. Claim: Maximizes value of growth, which is helped by the bidder-asker and strike price mechanisms.

7) Could apply the technology to exchanging other “perishable” assets at clusters of facilities, like pharmaceuticals, foods, etc., at healthcare facilities.

II. The Downside of Agency Staff

1) Lower quality (less Continuity of Care) with Agency usage.

2) Lower morale (less teamwork) with Agency usage.

3) Significantly higher price with Agency usage.

4) Although getting Agency staff is easier for the person doing the staffing (make one call), it still requires effort to determine needs in terms of Quality, Cost, and Morale.

III. The Upside of Joint Float Pool (i.e., Coordinated PRN) Staff

1) Fewer doubles and overtime cost.

2) Less overwork and stress injury.

3) Better teamwork and less co-worker resentment.

4) Better motivated staff as they want to be asked back and get bonuses.

IV. More Advantages

1) The “Network Effect” means that the more facilities cooperate, the more value they can all derive (i.e., the whole is greater than the sum of the parts).

2) That is, as there are more employees per facility, and then as more facilities join the JFP, the more opportunities will emerge.

3) Example: The telephone became exponentially more useful and valuable as the number of people you could (and eventually did) exchange conversations with increased.

V. Why There are Potential Cost Savings (Findings From Interviews)

1) Agency fees are double regular rates at both GoodSam & Augsburg, (e.g., NA=$16 instead of $8); LPN=$28 instead of $14; RN=$40 instead of $20), probably due to demand for staff being so high.

2) Almost every schedule has at least a few instances of overstaffing, or OS (whether due to Master Schedule, requests, or census drops).

3) Essentially, when a facility has either an OS or Agency shift, the facility overspends by an amount the same as the cost of that shift.

VI. Magnitude of Savings

1) If OS is the Overstaffing, and OT is the Overtime/Agency, the potential value to both facilities of transferring a . . .

2) Typical NA shift: OS covering OT=$128 TOTAL value

3) Typical LPN shift: OS covering OT=$224 TOTAL value

4) Typical RN shift: OS covering OT=$320 TOTAL value

VII. PRN/Float Pool Shortcomings

1) In most of the facilities studied by Applicants, a single facility PRN pool/Float pool is, in general, deficient because:

a) Facilities (e.g., Staffing Coordinators) complain that PRN staff do not come in when needed, so it's a waste of time to call them.

b) PRN Employees complain facilities don't give them enough of the “right” shifts, and that they can't wait by the phone. They need to take whatever shifts come to them as soon as possible.

VIII. Joint Employment

1) Many facilities know some of their PRN employees are working at other facilities. They just don't know exactly who or where.

2) One major chain hired PTEs into their “cluster pool” offering:

a) More shifts, more rewards, and less risk for the employee;

b) Better cost and continuity of care for the facilities;

c) Could hire them away from temp agencies, and still save money when paying them more, due to “Economies of Scale”—which is also achievable here.

IX. Incentives or Targeted Wage Differentials

1) At one facility, gift certificates of $25 are used to get people to come in when they were not supposed to come in.

2) Multi-facility PRN employees are currently not getting incentives to get shifts when working between facilities—so being incented to be jointly-employed is more than they have now.

3) Thus, $20-$60 could get some of them to go to a nearby facility when they were scheduled to work.

X. Why Would Employees Want To Do It?

1) Morale=(Staff's Expectations) minus (Their Perceived Fulfillment of Those Expectations).

2) Employees expect a certain number of shifts to get paid and accrue benefits.

3) However, at some facilities, on units where census drops, staff could be asked to go home, oftentimes having to take a Personal or Vacation day in the process.

4) JFP is an option for people not wanting to change their primary shift, cross job types, or scale back their work hours when facility needs to get down to budget.

5) Incentives ranging from 20%-33% (depending on tightness of labor market) of savings, can mean over 50% more pay than any single facility can offer, and also over 25% more than an Agency typically offers.

6) Now, staff could also have the option of getting a (20-33%) premium to work the JFP if they want the money or a change of scenery.

XI. Why Would Facilities Join In?

1) Resource Pooling makes all the members of the JFP more efficient both structurally (i.e., workforce configuration) and per schedule.

2) Parallels current approaches (switching units; managing PRN staff, and coordinating with their other jobs).

3) Significant cost and quality improvements possible.

4) Significant savings (64%) possible even with just 4% of staff (if we “square” the 80-20 rule).

5) Thus, coordinating the 2 facilities and an employee is a “win-win-win”.

6) Improve cost by >$4 k and coverage by >40 shifts per month.

7) (Converted to % improvements at end, in case interested in extrapolating): Improve cost by >4% and coverage by >4%.

As such, an invention has been disclosed in terms of preferred embodiments thereof which fulfill each and every one of the objects of the invention as set forth hereinabove and provides a new and useful process for labor arbitrage to improve healthcare labor market efficiency in an electronic business community of great novelty and utility.

Of course, various changes, modifications and alterations in the teachings of the present invention may be contemplated by those skilled in the art without departing from the intended spirit and scope thereof.

As such, it is intended that the present invention only be limited by the terms of the appended claims.

1. A method of conducting a labor arbitrage between a plurality of health care facilities, including the steps of:
a) creating an electronic business community made up of said plurality of health care facilities, including the steps of:
i) compiling information concerning all employees of each health care facility, and
ii) supplying said information to an exchange hub;
b) assessing labor resources of each health care facility, including the steps of:
i) assessing labor assets; and
ii) determining labor requirements;
c) deriving put and call option orders for each health care facility requiring same;
d) calculating value of option orders including determination of cost and value;
e) sending option orders to said exchange hub;
f) negotiating at least one deal between at least two of said health care facilities; and
g) closing said at least one deal.

2. The method of claim 1, wherein said compiling step includes the step of inputting information concerning employee names, identification codes, job descriptions, typical work hours, flexibility of work hours and dates of availability.

3. The method of claim 2, wherein said compiling step further includes the step of creating a master schedule indicating availability of each employee.

4. The method of claim 1, wherein said assessing step includes the step of comparing a staffing plan related to actual staff level with a listing of actual staffing needs.

5. The method of claim 4, further including the step of assessing said actual staffing needs in the absence of use of overtime pay and temporary employment agencies.

6. The method of claim 1, wherein said deriving step includes the step of deriving put orders by looking for employees whose job and shift are in excess of a desired quality level for a health care facility.

7. The method of claim 6, wherein said deriving step includes the step of deriving call orders by looking through jobs at a shift and discerning where a current staffing level is below an overtime level for a health care facility.

8. The method of claim 1, wherein said calculating step includes the steps of:
a) prioritizing size of return, namely, amount of monetary savings; and
b) effort of change based upon degree of employee flexibility.

9. The method of claim 8, wherein said calculating step regarding put option orders includes the step of calculating cost of overstaffing resulting when more employees are staffed, for a given job shift, than are needed.

10. The method of claim 9, wherein said calculating step regarding call option orders includes the step of calculating cost of overtime pay resulting where fewer employees are staffed, for a given job shift, than are needed.

11. The method of claim 1, wherein said negotiating step includes the step of creating a table of exchange values for all potential deals.

12. A method of conducting a labor arbitrage between a plurality of health care facilities, including the steps of:
a) creating an electronic business community made up of said plurality of health care facilities, including the steps of:
i) compiling information concerning all employees of each health care facility including the step of inputting information concerning employee names, identification codes, job descriptions, typical work hours, flexibility of work hours and dates of availability; and
ii) supplying said information to an exchange hub;
b) assessing labor resources of each health care facility, including the steps of:
i) assessing labor assets; and
ii) determining labor requirements whereby said assessing step includes the step of comparing a staffing plan related to actual staff level with a listing of actual staffing needs;
c) deriving put and call option orders for each health care facility requiring same, including the steps of:
i) deriving put orders by looking for employees whose job and shaft are in excess of a desired quality level for a health care facility; and
ii) deriving call orders by looking through jobs at a shaft and discerning where a current staffing level is below an overtime level for a health care facility;
d) calculating value of option orders including determination of cost and value;
e) sending option orders to said exchange hub;
f) negotiating at least one deal between at least two of said health care facilities; and
g) closing said at least one deal.

13. The method of claim 12, wherein said compiling step further includes the step of creating a master schedule indicating availability of each employee.

14. The method of claim 12, further including the step of assessing said actual staffing needs in the absence of use of overtime pay and temporary employment agencies.

15. The method of claim 12, wherein said calculating step includes the steps of:
a) prioritizing size of return, namely, amount of monetary savings; and
b) effort of change based upon degree of employee flexibility.

16. The method of claim 15, wherein said calculating step regarding put option orders includes the step of calculating cost of overstaffing resulting when more employees are staffed, for a given job shift, than are needed.

17. The method of claim 16, wherein said calculating step regarding call option orders includes the step of calculating cost of overtime pay resulting where fewer employees are staffed, for a given job shift, than are needed.

18. The method of claim 12, wherein said negotiating step includes the step of creating a table of exchange values for all potential deals.
